(19) United States
(12) Patent Application Publication
(10) Pub. No.: US 2022/0327644 A1
(43) Pub. Date: Oct. 13, 2022

(54) REAL ESTATE SALES DEVICE AND BYOD SYSTEM, METHOD, AND COMPUTER READABLE MEDIUM FOR REAL ESTATE AGENTS AND CLIENTS

(71) Applicant: AGENTONDUTY INC., Toronto (CA)

(72) Inventor: Amanda XIE, Etobicoke (CA)

(21) Appl. No.: 17/715,396

(22) Filed: Apr. 7, 2022

Related U.S. Application Data
(60) Provisional application No. 63/171,632, filed on Apr. 7, 2021.

(30) Foreign Application Priority Data
Jul. 16, 2021 (CA) 3124858

(51) Int. Cl. G06Q 50/16

(52) U.S. Cl. CPC G06Q 50/16

(57) ABSTRACT

A real estate matching and communication system includes: a dedicated application running on agent electronic devices; an on-duty button for selective engagement when a matching agent is on-duty; an available real estate listing for a property located within a predetermined range of a client's electronic device; an agent-on-duty listing for an on-duty agent with an electronic device located within a predetermined range of the client's electronic device; live communication between the electronic devices of the client and matching agent; a listing communication button that is selectively engageable by the matching agent to communicate with a listing contact to confirm terms for a potential transaction and arrange for the matching agent to show a corresponding real estate property to the client. There are also disclosed a corresponding real estate matching and communication device, method, and computer readable medium.

### FIELD OF THE INVENTION

The present invention relates generally to real estate sales systems and, more particularly, to real estate sales devices and BYOD (i.e., “bring your own device”) systems, methods, and computer readable media for real estate agents and clients.

### BACKGROUND OF THE INVENTION

In prior art related to real estate services, it may have been known to use sandwich boards and (e.g., “walk-ins welcome”) signs outside of real estate offices—i.e., when they were open and had an agent on duty. This prior art may, however, have suffered from one or more shortcomings. For example, the office location was fixed and/or required a client to be physically co-located with the signs and offices; and/or the office needed to be open and to have a licensed agent on duty at that very moment. This may have been a labor intensive activity, and/or limited by office hours and/or by space available at the real estate offices.

In addition, real estate offices may have maintained duty rosters—e.g., print versions and actual calendars—to record and display names of on-duty real estate agents and corresponding dates and times. This prior art may, however, have suffered from one or more shortcomings. For example, each duty roster may have only been available for and available within a particular real estate office; the time may have been fixed for each agent; if real estate agents missed their scheduled times, they may have lost the chance to get new leads; and/or the “on duty” hours available to each real estate agent may have been limited.

Also, real estate offices may have presented their real estate listings in window displays visible to passers-by. This prior art may, however, have suffered from one or more shortcomings. For example, the prior art real estate office window listing display may have been fixed; the office may have been required to be located in a high-traffic area for clients to encounter the window listing display; it may have been needed, preferable, and/or somewhat expensive to illuminate the window listing display, e.g., in a lightbox, at night time; and/or the window listing inserts may need to have been changed on a regular basis to keep it from becoming outdated.

Typically, “brick-and-mortar” real estate offices were located in high traffic areas (e.g., on retail levels) where such passers-by, including potential clients, might have readily encountered them. This prior art may, however, have suffered from one or more shortcomings. For example, it may have been relatively expensive to rent or own a real estate office in a high traffic area; and/or there may have been limited, little, and/or no ability to adjust the size of the real estate office depending on how many agents might be employed there, e.g., as the real estate business grows and/or shrinks.

In the prior art, a receptionist in a real estate office might have been available to receive and convey (to real estate agents) telephone messages, voicemails, and/or emails from clients and potential clients awaiting replies. This prior art may, however, have suffered from one or more shortcomings. For example, if a client walked into the office and no agent was on duty, then the client may have wasted their time by speaking to the receptionist (especially, e.g., if the client needed an answer right away; if a client obtained a real estate agent's phone number and/or email, then the client may have been unable to obtain instant service; the real estate agents may not have been willing and able, or otherwise ready for new clients and/or new challenges, e.g., based on their own schedules.

Current contact information for real estate agents and brokerages may have been found on websites they maintained, and in print and online phone books. This prior art may, however, have suffered from one or more shortcomings. For example, when a client sought a local real estate agent, they might need to review print and online yellow pages, various agent websites, and public listing portals without any built-in ability to connect with a live agent. Clients may have called and phones may have rung until voicemail picked up. Such calls and/or voicemails may have even resulted in long distance charges. When an agent's phone was listed, there may have been uncertainty over whether it was a cell phone and/or whether a client might send a text message to the agent. In some cases, clients may have emailed agents, and then would need to wait (e.g., an hour or a day) for a reply if any. Sometimes, such emails may have gone to spam, etc. In some cases, a potential client might have contacted an agent who was not the sought-after local expert, but was instead working principally in another neighbourhood of the city, with little or no knowledge of the desired properties and/or neighbourhoods in which the client was interested. For example, a client may have sought a Mississauga real estate agent online and found an agent who (through search engine optimization, etc.) was ranked first in the Greater Toronto Area, but that agent may have been principally working in another part of the region—e.g., in Ajax or Pickering—without any particular local expertise in the Mississauga area.

Online multiple listing service websites (or “MLS sites”) may have presented real estate listings from a variety of different real estate agents and brokerages. Public and/or private MLS sites and online portals may have been segmented by areas, cites, regions, countries, etc. MLS systems may have only existed in Canada and/or the United States. The largest public listing portal in Canada, accessible via the realtor.ca domain name, may host all or substantially all of the MLS listings from real estate boards across Canada. The largest public listing portal in the United States may be Zillow, which presents more than perhaps about 70% of the MLS listing feeds. There may, however, be no global real estate listing portal for either MLS, private/exclusive listings, or combined MLS and private/exclusive listings.

In the prior art, owners and/or sellers may have been unable to list their own properties on MLS directly, and have been required to hire real estate agents to put listings on MLS. It may not have been possible to enter a real estate listing on a local real estate board (e.g., a local MLS board) unless a local realtor was hired. Currently, real estate brokerages may require licenses to operate in any particular province in Canada and/or in any particular state in the United States.

The MLS prior art may have suffered from one or more shortcomings. For example, MLS services may have been controlled by local real estate boards, and/or organized by city boundaries. Real estate agents with the Toronto Real Estate Board, for example, may have had no right to list properties for sale in Vancouver if they were not licensed in the province of British Columbia.

Also, when homeowners or sellers wanted to list houses and/or properties for sale, they may have placed advertisements in local newspapers or listed them for sale in appropriate sections of Craigslist (e.g., in the Vancouver area). Yet, potential buyers who encountered such property listings may have been remote from the properties, and from such areas, and/or may have found it difficult to imagine the neighborhoods.

Some prior art sites (for example, Kijiji and Craiglist) may have allowed owners to list their own properties for sale. In the prior art, however, there may have been no unified sites that presented any and all listings offered “for sale by owners”, and/or for lease by owners, (generally, “FSBO” sites) for any city and/or country. This prior art may, however, have suffered from one or more shortcomings. For example, FSBO sites may have offered inadequate exposure, e.g., in comparison to MLS sites which may have featured more than about 95% of the properties available for residential real estate transactions.

Only realtors, with valid real estate licenses, may have been able to enter new property listings on MLS sites. As such, if homeowners wanted to list their properties on MLS sites, then they may have been required to pay two different real estate agents' commissions (i.e., those of the listing agent and the buyer's agent). In the prior art, real estate brokerages may have only been able to operate by registering a business under local licensing, and/or by hiring licensed local agents. They may have been prevented from listing and/or selling houses unless they had a real estate license.

The prior art may have included complicated referral procedures for real estate agents in the United States and Canada. These procedures may have required the signing of a referral agreement, negotiations, disclosure of client information, other criteria, etc. Two agents may have been required to sign a referral agreement even before any related work could be started. It may have required one or both of them to invest a significant amount of time and/or effort to find an appropriate agent in the desired destination. Among other things, it may have been necessary to confirm that a local agent was willing and able to perform the required real estate work (e.g., not on vacation, not retired) and to take on new clients. After negotiating and agreeing upon applicable referral fees, the referral agreement was signed. Real estate industry referral fees can be relatively high—e.g., across the United States, referral fees can be about 25%, about 35%, or even about 50%. Often, even after negotiating all that, a signed referral agreement may have ended and/or expired without ever having been utilized.

Traditional advertising for real estate listings and/or for real estate agents (e.g., on park benches, at bus stops, on social media, cards and other direct and/or unaddressed mailings) may have been relatively expensive. This prior art may have suffered from one or more further shortcomings. For example, apart from the cost, the real estate agent's potential return on investing in any such advertising may have been somewhat limited.

What may be needed are real estate sales devices and BYOD systems, methods, and computer readable media for real estate agents and clients that improve users' experiences and/or provide for better outcomes in real estate transactions.

It may be an object according to one aspect of the invention to provide real estate sales devices and BYOD systems, methods, and computer readable mediums for real estate agents and clients.

It is an object of the present invention to obviate or mitigate one or more disadvantages and/or shortcomings associated with the prior art, to meet or provide for one or more desires, benefits, needs and/or advantages, and/or to achieve one or more objects of the invention—one or more of which may preferably be readily appreciable by and/or suggested to those skilled in the art in view of the teachings and/or disclosures hereof.

### SUMMARY OF THE INVENTION

According to the invention, there is disclosed a real estate matching and communication system. The system may preferably be for use with: at least one real estate property listed as available for a potential transaction by a listing contact; a client's electronic device that may preferably be local to a client; and one or more agent electronic devices that may preferably be local to agents, including a matching agent's electronic device that may preferably be local to a matching agent. The system may preferably include a dedicated application running on the agent electronic devices. It may also preferably include an on-duty button that may preferably be presented to the matching agent via the dedicated application and the matching agent's electronic device. The on-duty button may preferably be selectively engaged by the matching agent to indicate when the matching agent may preferably be on-duty. The system may also preferably include client listings presented to the client via the client's electronic device. The client listings may preferably include at least one available real estate listing, corresponding to the real estate property, when the real estate property may preferably be physically located within a predetermined property range of the client's electronic device. The client listings may also preferably include an agent-on-duty listing which corresponds to the matching agent when the matching agent may preferably be indicated as on-duty and the matching agent's electronic device may preferably be physically located within a predetermined agent range of the client's electronic device. The system may also preferably include an agent-on-duty communication button, substantially adjacent to the client listings, that may preferably be selectively engageable by the client. The system may preferably include an alert notification that may preferably be presented to the matching agent, via the dedicated application, after the client may preferably have selected the agent-on-duty communication button. Whereupon, the client's electronic device and the dedicated application may preferably enable live communication, between the client and the matching agent, of inputs received by the client's electronic device and the matching agent's electronic device. The inputs may preferably include a member selected from the group consisting of text and voice. The system may preferably include an agent listing that presents the available real estate listing to the matching agent via the dedicated application. The system may also preferably include a listing communication button, substantially adjacent to the agent listing, that may preferably be selectively engageable by the matching agent to communicate with the listing contact to confirm terms for the potential transaction and arrange for the matching agent to show the real estate property to the client.

According to one aspect of the invention, the available real estate listing may preferably, but need not necessarily, include a location, one or more photographs, and/or an asking price associated with the real estate property.

According to one aspect of the invention, the predetermined agent range may preferably, but need not necessarily, be automatically predetermined in dependent relation on one or more factors selected from the following: a local population density; a local client density; a local property listing density; and/or a local agent-on-duty density.

According to one aspect of the invention, the system may preferably, but need not necessarily, include a local map element that may preferably, but need not necessarily, present geographical areas to the client via the client's electronic device. The geographical areas may preferably, but need not necessarily, be local to the client's electronic device. The predetermined property range may preferably, but need not necessarily, be predetermined in dependent relation on the geographical areas presented via the local map element. The available real estate listing may preferably, but need not necessarily, be presented via the local map element.

According to one aspect of the invention, the local map element may preferably, but need not necessarily, be selectively re-scaled to present the geographical areas at smaller and/or larger scales, and/or to modify the predetermined property range accordingly.

According to one aspect of the invention, the agent listing also may preferably, but need not necessarily, present the terms for the potential transaction to the matching agent. The terms may preferably, but need not necessarily, include a referral fee that the listing contact may preferably, but need not necessarily, agree to pay the matching agent after the potential transaction has successfully closed.

According to one aspect of the invention, the system may preferably, but need not necessarily, include a transaction reporting button that may preferably, but need not necessarily, be selectively engageable by the matching agent and/or the listing contact to report after the potential transaction has successfully closed.

According to one aspect of the invention, the system may preferably, but need not necessarily, include a payment button that may preferably, but need not necessarily, be selectively engageable by the listing contact to pay the referral fee to the matching agent, via the dedicated application, after the potential transaction has successfully closed.

According to one aspect of the invention, the system may preferably, but need not necessarily, be for use by an administrator of the dedicated application. The dedicated application may preferably, but need not necessarily, pay a portion of the referral fee to the matching agent and/or a remainder of the referral fee to the administrator, after the listing contact has selected the payment button.

According to one aspect of the invention, the system may preferably, but need not necessarily, include an administrative backend that presents data associated with payment, the terms for the potential transaction, and/or one or more of the following: the client, the agents, the client listings, communication between the client and the matching agent, and/or communication between the matching agent and the listing contact.

According to one aspect of the invention, the system may preferably, but need not necessarily, include a posting button that may preferably, but need not necessarily, be selectively engageable by the listing contact to post the real estate property before the available real estate listing may preferably, but need not necessarily, be presented to the client.

According to one aspect of the invention, the dedicated application may preferably, but need not necessarily, present the posting button to the agents. The posting button may preferably, but need not necessarily, be selectively engageable by one of the agents as the listing contact. The agent-on-duty listing may preferably, but need not necessarily, include information about the matching agent and/or any properties directly posted by the matching agent using the posting button.

According to one aspect of the invention, the system may preferably, but need not necessarily, be for use with a Multiple Listing Service (“MLS”) database that may preferably, but need not necessarily, be remote from the agent electronic devices and/or the client's electronic device. The client listings may preferably, but need not necessarily, include one or more MLS listings reproduced from the MLS database. The available real estate listing may preferably, but need not necessarily, correspond to one of the MLS listings.

According to one aspect of the invention, the MLS listings may preferably, but need not necessarily, be automatically reproduced and/or downloaded from the MLS database.

According to the invention, there is also disclosed a method of real estate matching and communication. The method may preferably be for use with: at least one real estate property listed as available for a potential transaction by a listing contact; a client's electronic device that may preferably be local to a client; and one or more agent electronic devices that may preferably be local to agents, including a matching agent's electronic device that may preferably be local to a matching agent. The method may preferably include a real estate application providing step of providing a dedicated application running on the agent electronic devices. The method may also preferably include an on-duty step of providing an on-duty button that may preferably be presented to the matching agent via the dedicated application and the matching agent's electronic device. The on-duty button may preferably enable selective engagement by the matching agent to indicate when the matching agent may preferably be on-duty. The method may preferably include a client listing step of presenting client listings to the client via the client's electronic device. The client listings may preferably include at least one available real estate listing, corresponding to the real estate property, when the real estate property may preferably be physically located within a predetermined property range of the client's electronic device. The client listings may preferably include an agent-on-duty listing which corresponds to the matching agent when the matching agent may preferably be indicated as on-duty and the matching agent's electronic device may preferably be physically located within a predetermined agent range of the client's electronic device. The method may preferably include an agent-on-duty communication step of providing an agent-on-duty communication button, substantially adjacent to the client listings, that may preferably be selectively engageable by the client. In the agent-on-duty communication step, an alert notification may preferably be provided and presented to the matching agent, via the dedicated application, after the client may preferably have selected the agent-on-duty communication button. Whereupon, the client's electronic device and the dedicated application may preferably enable live communication, between the client and the matching agent, of inputs received by the client's electronic device and the matching agent's electronic device. The inputs may preferably include a member selected from the group consisting of text and voice. The method may preferably include an agent listing step of providing an agent listing that may preferably present the available real estate listing to the matching agent via the dedicated application. The method also may preferably include a listing contact communication step of providing a listing communication button, substantially adjacent to the agent listing, that may preferably be selectively engageable by the matching agent to communicate with the listing contact to confirm terms for the potential transaction and arrange for the matching agent to show the real estate property to the client.

According to one aspect of the invention, the method may preferably, but need not necessarily, include an agent range determination step before the client listing step. In the agent range determination step, the predetermined agent range may preferably, but need not necessarily, be automatically predetermined in dependent relation on one or more factors selected from the following: a local population density; a local client density; a local property listing density; and/or a local agent-on-duty density.

According to one aspect of the invention, in the client listing step, a local map element may preferably, but need not necessarily, present geographical areas to the client via the client's electronic device. The geographical areas may preferably, but need not necessarily, be local to the client's electronic device. The method may preferably, but need not necessarily, include a property range determination step before the client listing step. In the property range determination step, the predetermined property range may preferably, but need not necessarily, be predetermined in dependent relation on the geographical areas presented via the local map element. In the client listing step, the available real estate listing may preferably, but need not necessarily, be presented via the local map element.

According to one aspect of the invention, in the agent listing step, the agent listing may preferably, but need not necessarily, present the terms for the potential transaction to the matching agent. The terms may preferably, but need not necessarily, include a referral fee that the listing contact may preferably, but need not necessarily, agree to pay the matching agent after the potential transaction has successfully closed. The method may preferably, but need not necessarily, include a transaction reporting step, after the listing contact communication step, of providing a transaction reporting button that may preferably, but need not necessarily, be selectively engageable by the matching agent and the listing contact to report after the potential transaction may preferably, but need not necessarily, have successfully closed.

According to one aspect of the invention, the method may preferably, but need not necessarily, include a payment step, after the transaction reporting step, of providing a payment button that may preferably, but need not necessarily, be selectively engageable by the listing contact to pay the referral fee to the matching agent, via the dedicated application, after the potential transaction may preferably, but need not necessarily, have successfully closed.

According to one aspect of the invention, the method may preferably, but need not necessarily, include a posting step, before the client listing step, of providing a posting button that may preferably, but need not necessarily, be selectively engageable by the listing contact to post the real estate property before the available real estate listing may preferably, but need not necessarily, be presented to the client. The dedicated application may preferably, but need not necessarily, present the posting button to the agents. The posting button may preferably, but need not necessarily, be selectively engageable by one of the agents as the listing contact. The agent-on-duty listing may preferably, but need not necessarily, include information about the matching agent and any properties directly posted by the matching agent using the posting button.

According to the invention, there are also disclosed real estate sales devices and BYOD systems, methods, and computer readable media for real estate agents and clients. A software application or “app” may preferably be embodied in a device and/or BYOD system, method, and/or computer readable medium according to the invention. Preferably, the app (or “program” or “platform” or “portal”) may provide one or more features, elements, components, parts, and/or steps that work together as described elsewhere herein. The app may preferably, but need not necessarily, function perhaps at least in part on a mobile and/or software-as-a-service (or “SaaS”) model.

According to one aspect of the invention, the devices, systems, methods, and/or computer readable media may preferably, but need not necessarily, provide clients and/or potential clients with substantially instant access to nearby live real estate agents. Clients may preferably, but need not necessarily, never have to look for an “agent on duty” sign or placard in town, nor walk into a real estate office. According to the invention, there may preferably, but need not necessarily, be no need for any “agent on duty” sandwich board to be set out in front of a real estate office. The app may preferably, but need not necessarily, provide home buyers and/or sellers with a comfortable user experience from where they are, and/or when they want, to connect with a real estate agent on duty. Preferably, but not necessarily, home buyers and/or sellers may connect with a real estate agent with one click of a button, preferably without being limited by office hours, locations, and/or brands.

According to one aspect of the invention, the app may preferably, but need not necessarily, provide smart and/or live “yellow pages” functionality, preferably with a substantially instant connection to a real estate agent. Preferably, but not necessarily, potential clients using the app would no longer need to wait for ten phone rings, to leave voice messages, or to wait for an email reply. The app may preferably, but need not necessarily, look for a nearby agent on duty who may preferably be ready to take customer calls. Preferably, but not necessarily, the app may search for the agent closest to the client user. Preferably, but not necessarily, when both agents may be about the same geographical distance from the client user, the app may preferably determine which agent first signed in as “on duty”. Preferably, but not necessarily, when both agents signed in as “on duty” at about the same time (e.g., with reference to time stamps that include seconds), then the app may preferably determine which agent has used the app for longer. Preferably, but not necessarily, the app may review all of this data and/or may direct the potential client for connection with the appropriate real estate agent substantially instantaneously (e.g., in less than about a third of a second).

According to one aspect of the invention, the app may preferably, but need not necessarily, enable and/or help real estate agencies to reduce and/or eliminate expensive brick-and-mortar offices (e.g., to save on expensive rent and/or ownership of real estate offices) which otherwise may have principally been used to generate leads for real estate agents.

According to one aspect of the invention, the app may preferably, but need not necessarily, help clients to find local “on duty” real estate agents, preferably without requiring the agents to chase leads, and/or in addition or instead preferably enabling them to just wait for their phones to ring. According to the invention, agents may preferably, but need not necessarily, be required to spend little, less, or no money on advertising for new leads. The app may preferably, but need not necessarily, provide real estate agents with a virtual pipeline of new leads on their phone. According to the invention, the app may preferably, but need not necessarily, provide real estate agents with greater control over their own schedules, and/or with a ready ability to choose when and/or where to go “on duty” and take new calls (or to be off duty).

According to one aspect of the invention, the app may preferably, but need not necessarily, enable and/or help an agent duty roster to be shared among agents from different real estate offices, preferably serving the same client pool and/or in substantially the same area. For example, there may be two real estate offices within a block away from each other. In the prior art, if there was a buyer and/or seller who wanted to speak with a real estate agent, they may have been required to decide which office to contact. If there was no one in the first office that they contacted, then the buyer and/or seller may have been required to contact the second office. Even then, there may have been no agent on duty to speak with them (for example, after hours or on weekends, both offices may have been closed). According to the invention, however, the potential client may preferably, but need not necessarily, readily open the app and/or request to be connected with an agent on duty. Preferably, but not necessarily, substantially instantaneously, the app may then preferably connect them with whichever on-duty agent may be closest to them.

According to one aspect of the invention, with the app, a real estate office may preferably, but need not necessarily, have no further need to set up a duty roster. Unlike anything in the prior art, the app may preferably, but need not necessarily, provide an “organic” roster depending on logged-in agents. Many agents may preferably, but need not necessarily, be available at the same time. According to the invention, the app and/or system may preferably, but need not necessarily, only connect the potential client with the closest agent to the client. Preferably, in this way, the app may preferably, but need not necessarily, help to best serve the client and/or to connect them with a real estate agent who may preferably be knowledgeable about real estate in the client's location. Preferably, although without intending to be bound by theory, it may be believed that the closer a potential client is to a real estate agent, the more common ground they might share with each other. Preferably, but not necessarily, the app may help to increase any chance of “lead conversion” and/or that the potential client and real estate agent will be able to do business together. According to the invention, the app may preferably, but need not necessarily, enable and/or help agents from different real estate franchises, companies, and/or agencies (e.g., operating under different real estate office brands) to share substantially the same duty roster and/or to serve substantially the same client pool.

According to one aspect of the invention, the app may preferably, but need not necessarily, enable and/or help clients to see (e.g., on their mobile devices) properties for sale and/or lease around them. With the app, clients may preferably, but need not necessarily, have no further need to look for listings in local real estate office windows. With the app, real estate offices may preferably, but need not necessarily, have little, less, or no need to obtain and/or maintain an expensive window display of real estate listings. The app may preferably, but need not necessarily, enable and/or help listings displayed in real estate office windows to be replaced and/or supplemented by a map which may preferably be accessed using the app, and/or seen by more people, preferably without requiring them to be physically present at the real estate office's location.

According to one aspect of the invention, the app may preferably, but need not necessarily, enable and/or help clients and/or potential clients to call real estate agents whenever and/or wherever may be most convenient for them. Use of the app may preferably, but need not necessarily, help to reduce, minimize, and/or eliminate any need for cold calls and/or prospect calls.

According to one aspect of the invention, the app may preferably, but need not necessarily, enable and/or help clients and/or potential clients to speak with a live real estate agent who may preferably be on duty. The app may preferably, but need not necessarily, enable and/or help clients and/or potential clients to substantially instantaneously consult with an on-duty real estate agent for free. With the app, clients and/or potential clients may preferably, but need not necessarily, never again need to leave a voicemail and/or telephone message for a real estate agent, and/or to wait for an agent to get back to them.

According to one aspect of the invention, the app may preferably, but need not necessarily, enable and/or help potential clients and/or agents to connect with nearby people. With the app, there may preferably, but need not necessarily, be a greater likelihood that connected users will speak the same language, and/or a greater ability to talk about local neighborhoods.

According to one aspect of the invention, the app may preferably, but need not necessarily, compile and/or present all local listings as being for sale by the local real estate agent (e.g., “For Sale by <insert name of connected on-duty local real estate agent>”). The app may preferably, but need not necessarily, help to establish connected on-duty local real estate agents as having expertise with local real estate listings.

According to one aspect of the invention, the app may preferably, but need not necessarily, help real estate agents avoid worrying about new leads. A real estate agent may preferably, but need not necessarily, simply turn on their phone, and/or new leads will be presented to them. Real estate agent use of the app may preferably, but need not necessarily, be substantially free and/or substantially unlimited. Use of the app may preferably, but need not necessarily, afford real estate agents with a flexibility to set up their own schedules and/or to readily control an area in which they would like to show properties, e.g., by simply staying in their preferred area. The app may preferably, but need not necessarily, charge only a small referral fee on completed transactions stemming from the app. This referral fee may preferably, but need not necessarily, be highly favourable in comparison to real estate industry averages (e.g., perhaps about 70% lower than industry averages). The app may preferably, but need not necessarily, provide for significant monetary savings by real estate agents.

According to one aspect of the invention, sellers may preferably, but need not necessarily, be required to only pay one real estate agent's fee and/or commission.

According to one aspect of the invention, the app may preferably, but need not necessarily, help to remove one or more barriers that may have been previously associated with MLS listing boards. The app may preferably, but need not necessarily, enable and/or help anyone—homeowners and real estate agents alike—to input real estate property listings for sale via the app as a single portal. The app may preferably, but need not necessarily, include, compile, store, and/or present all or substantially all MLS board data feeds in the United States and/or Canada. The app may preferably, but need not necessarily, provide a single portal that may preferably hold all or substantially all MLS listings. The app may preferably, but need not necessarily, include, compile, store, and/or present the MLS listing feeds only when a user is using the app. Preferably, when a user is using the app, application programming interface (“API”) calls may preferably, but need not necessarily, be substantially instantaneously initiated in an appropriate manner—e.g., using a predetermined set of application functions and/or procedures to access features and/or data of a local MLS system. Any “agent on duty” (or “AOD”) listings—as described elsewhere herein—may preferably, but need not necessarily, be presented (e.g., on a map element visible within the app) substantially right away, preferably followed by MLS listings perhaps within, e.g., a couple of seconds after the user starts the app. The app may preferably, but need not necessarily, help potential clients to locate real estate listings of potential interest, e.g., without searching.

According to one aspect of the invention, the app may preferably, but need not necessarily, enable and/or help homeowners and/or sellers to list their properties for sale on the same portal as any and/or all MLS properties listed by real estate agents.

According to one aspect of the invention, the app may preferably, but need not necessarily, include a global listings inventory which may preferably combine all or substantially MLS properties listed by real estate agents and/or all properties listed for private sale by homeowners within the app. Each listing in this global listings inventory may preferably, but need not necessarily, pinned onto the map element according to a listing geolocation. According to the invention, the app may preferably, but need not necessarily, determine a local map portion of the map element that corresponds to a user geolocation. The app may preferably, but need not necessarily, display and/or present the user with the local map portion, and/or with each listing (pinned onto the map element as aforesaid) that has a listing geolocation within the local map portion. In this manner, the app may preferably, but need not necessarily, display and/or present the user with each listing pinned onto the local map portion. The app may preferably, but need not necessarily, enable and/or help users (e.g., local clients and/or agents) to see a smart subset of the global listings inventory that matters to them.

According to one aspect of the invention, the app may preferably, but need not necessarily, enable and/or help with introduction and/or with increased adoption of co-broker (e.g., multiple agent services and/or a multiple listing service) selling in, to, and/or with regions and/or countries—e.g., outside the United States and Canada—where co-broker selling may have significant room for growth. The app may preferably, but need not necessarily, allow agents and/or owners to add a certain number of listings (e.g., three listings) to the portal. Any and/or all payment and/or selling of real estate properties may preferably, but need not necessarily, occur outside of the app, preferably after the app has connected the client and real estate agent. In this manner, the app may preferably, but need not necessarily, have little, less, or no need to further navigate and/or comply with local real estate practices and/or by-laws, and/or may leave real estate sales to be completed as among the local clients (or buyers), agents, and/or sellers. The app and/or platform may preferably, but need not necessarily, simply be provided with a referral fee after a successful transaction.

According to one aspect of the invention, the app may preferably, but need not necessarily, provide real estate agents with free leads, preferably without requiring them to spend any money on advertising for new business.

According to one aspect of the invention, the app may preferably, but need not necessarily, include a revenue model. The revenue model may preferably, but need not necessarily, enable real estate agents and/or homeowners to freely advertise their properties for sale within the app. In the revenue model, the app may preferably, but need not necessarily, only require the agents to pay a referral fee after a real estate transaction, stemming from use of the app, has been successfully completed.

According to one aspect of the invention, the app may preferably, but need not necessarily, enable and/or help with simplification of the referral process. The app may preferably, but need not necessarily, enable and/or help remote real estate agents and/or owners with a property for sale to save significant time, effort, and/or expense that otherwise could be associated with locating and/or vetting an appropriate real estate agent local to the property, and/or subsequently drafting and/or negotiating a referral fee agreement, etc.

According to one aspect of the invention, the app may preferably, but need not necessarily, provide real estate agents worldwide with a platform to receive free, unlimited local leads. The referral fee may preferably, but need not necessarily, be only about 0.2% of the transaction amount, according to the invention, after the real estate sale has been completed. The referral fee is preferably paid by the local real estate agent, from their commission, to a service provider and/or administrator of the app. [Aside: In the prior art, a buyer's real estate agent may have typically received a commission of about 2.5% or 3%, and industry-standard referral charges may have been in the order of between about 25% and about 50% (with an average of perhaps about 35%) of that commission, in North America.] Favourably, the referral fee of 0.2% of the transaction amount according to the invention may preferably, but need not necessarily, amount to somewhere between about 6% and about 8% of a local real estate agent's referral fee (at about 25% to about 35%) in North America. According to the invention, the app may preferably, but need not necessarily, afford local real estate agents with a savings of perhaps about 70% in comparison to industry-standard referral charges in the prior art.

According to one aspect of the invention, preferably after real estate agents have downloaded the app, the app may preferably, but need not necessarily, afford them with one or more functionalities of virtual real estate offices on their mobile devices, preferably as they wait to serve their local communities, worldwide. The app may preferably, but need not necessarily, enable and/or help a local real estate agent—preferably one who has logged in as “on duty” using the app—to have access to properties listed for sale by any brand and/or franchised real estate brokerage. Service providers and/or administrators of the app may preferably, but need not necessarily, generate revenue and/or receive referral fees from any completed real estate transactions stemming from the app. The app may preferably, but need not necessarily, enable and/or help bring together one or more networks of real estate agents, preferably without hiring and/or managing any real estate agents and/or properties.

Persons skilled in the art will appreciate in view of the teachings and disclosures herein that the real estate sales devices and BYOD systems, methods, and computer readable mediums for real estate agents and clients according to the invention offer significant advantageous utilities and/or functionality in comparison to the prior art.

Other advantages, features, and/or characteristics of the present invention, as well as methods of operation and functions of the related elements of the structure, operation, and/or the combination of parts, features, and/or economies of manufacture, will become more apparent upon consideration of the detailed description with reference to the figures which accompany this application, and/or to any figures which may accompany any applications claiming priority herefrom.

### BRIEF DESCRIPTION OF THE DRAWINGS

The novel features which are believed to be characteristic of the present invention, and related devices, systems, methods, and/or computer readable media according to the present invention, as to their structure, organization, use, and/or method of operation, together with further objectives and advantages thereof, may be better understood from the figures which accompany this application, in which presently preferred embodiments of the invention have been illustrated by way of example. It is expressly understood, however, that such figures have been provided for the purpose of illustration and/or description only, and not intended as a definition of the limits of the invention. In the accompanying drawings:

FIG. 1 depicts a screenshot from an app according to a preferred embodiment of the invention, shown with a seller button thereof highlighted;

FIG. 2 depicts another screenshot from the app of FIG. 1;

FIG. 3A and FIG. 3B together depict a posting screen from the app of FIG. 1;

FIG. 4 depicts a listing preview screen from the app of FIG. 1;

FIG. 5 depicts a listing screen from the app of FIG. 1;

FIG. 6 depicts a seller menu from the app of FIG. 1;

FIG. 7 depicts an agent on-duty button and communication history screen from the app of FIG. 1;

FIG. 8 depicts an agent alert notification from the app of FIG. 1;

FIG. 9 depicts an agent listing screen from the app of FIG. 1;

FIG. 10 depicts another agent listing screen from the app of FIG. 1;

FIG. 11 depicts a further agent listing screen from the app of FIG. 1;

FIG. 12 depicts a login screen from the app of FIG. 1;

FIG. 13 depicts a further screenshot from the app of FIG. 1, shown with a landlord button thereof highlighted;

FIG. 14 depicts a further screenshot from the app of FIG. 1, shown with a buyer button thereof highlighted;

FIG. 15 depicts a buyer menu from the app of FIG. 1;

FIG. 16 depicts an account creation screen from the app of FIG. 1;

FIG. 17 depicts a contact support screen from the app of FIG. 1;

FIG. 18 depicts a settings screen from the app of FIG. 1;

FIG. 19 depicts a seller's communication screen from the app of FIG. 1;

FIG. 20 depicts a listings screen from the app of FIG. 1;

FIG. 21 depicts a seller's communication history screen from the app of FIG. 1;

FIG. 22 depicts a property listing for rental screen from the app of FIG. 1;

FIG. 23 depicts a property listing for sale screen from the app of FIG. 1;

FIG. 24 depicts an agent's listing screen from the app of FIG. 1;

FIG. 25 depicts another agent on-duty button and communication history screen from the app of FIG. 1;

FIG. 26 depicts an agent on-duty button and listings screen from the app of FIG. 1;

FIG. 27 depicts an agent menu from the app of FIG. 1;

FIG. 28 depicts a transaction history screen from the app of FIG. 1;

FIG. 29 depicts another transaction screen from the app of FIG. 1;

FIG. 30 depicts a payment screen from the app of FIG. 1;

FIG. 31 depicts an administrator's agent listing screen from the app of FIG. 1;

FIG. 32 depicts an administrator's property listing screen from the app of FIG. 1;

FIG. 33 depicts an administrator's communication history screen from the app of FIG. 1;

FIG. 34 depicts the app of FIG. 1, shown in an online app store;

FIG. 35 depicts an agent menu from an app according to another preferred embodiment of the invention;

FIG. 36 depicts an agent listing screen from the app of FIG. 35;

FIG. 37 depicts a listing preview screen from the app of FIG. 35;

FIG. 38 depicts a posting screen from the app of FIG. 35; and

FIG. 39 depicts a seller menu from the app of FIG. 35.

This disclosure, including the accompanying drawings, may include one or more numbers, words, phrases, sentences, menu items, arrangements, and/or configurations which may be included by way of example. It may bear repeating, in this respect specifically, that such drawings and/or this disclosure are for the purpose of illustration and description only, and not intended as a definition of the limits of the invention.

### DETAILED DESCRIPTION OF PREFERRED EMBODIMENTS

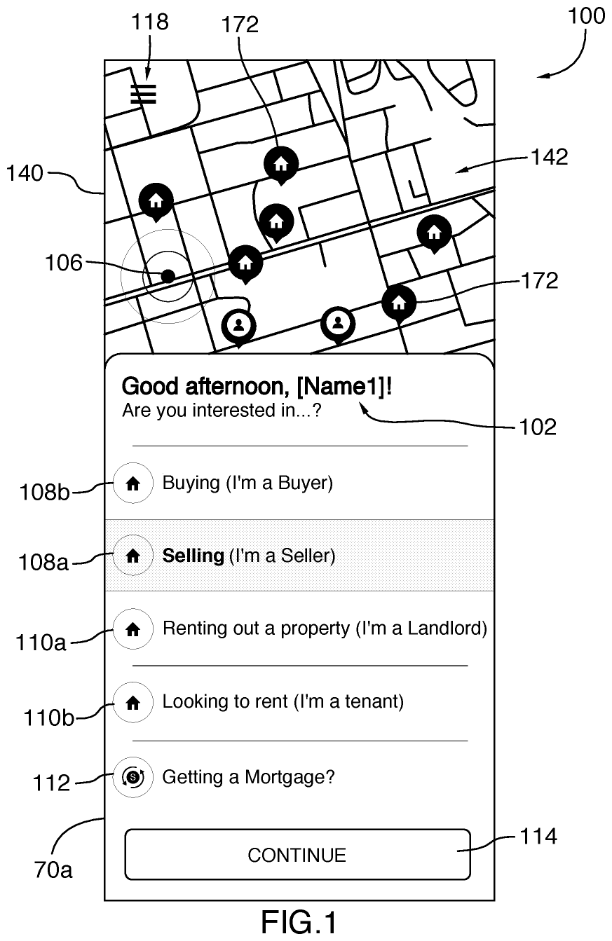

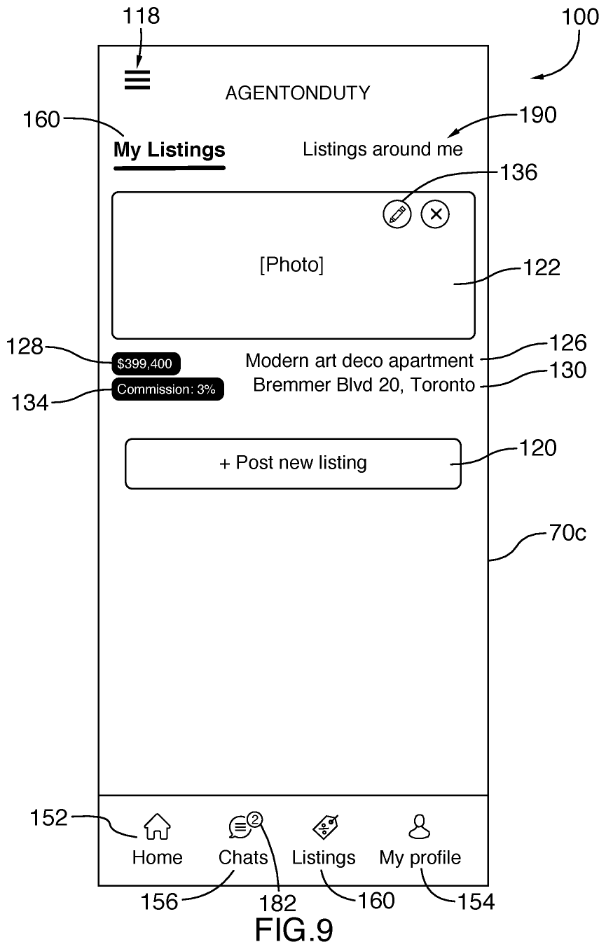

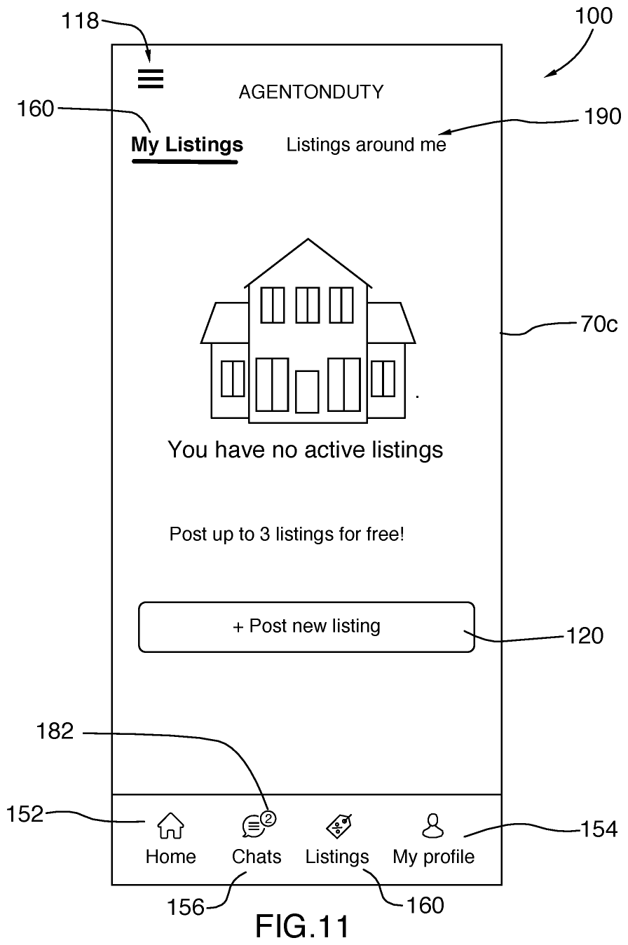

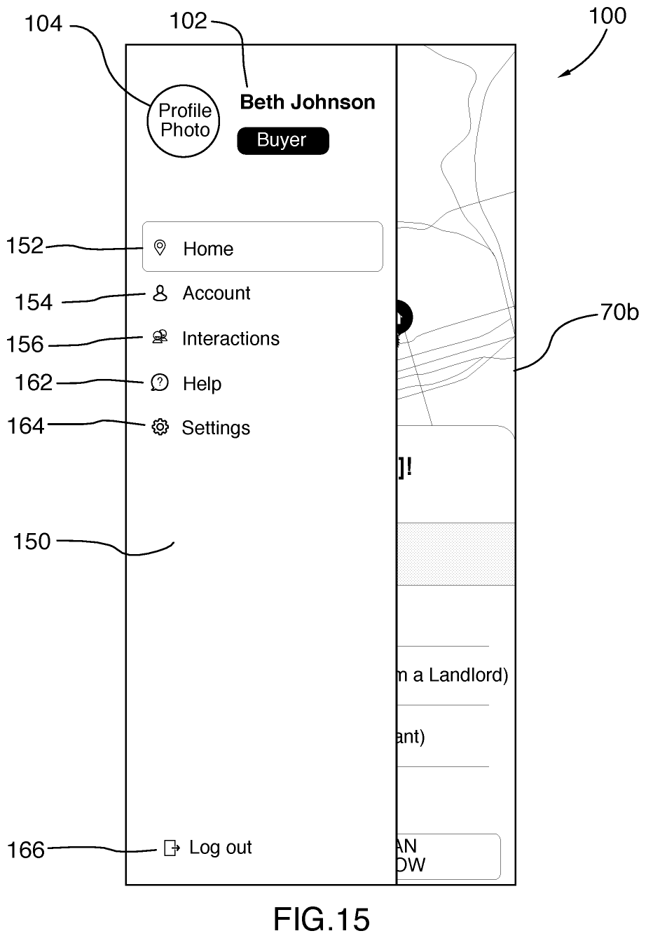

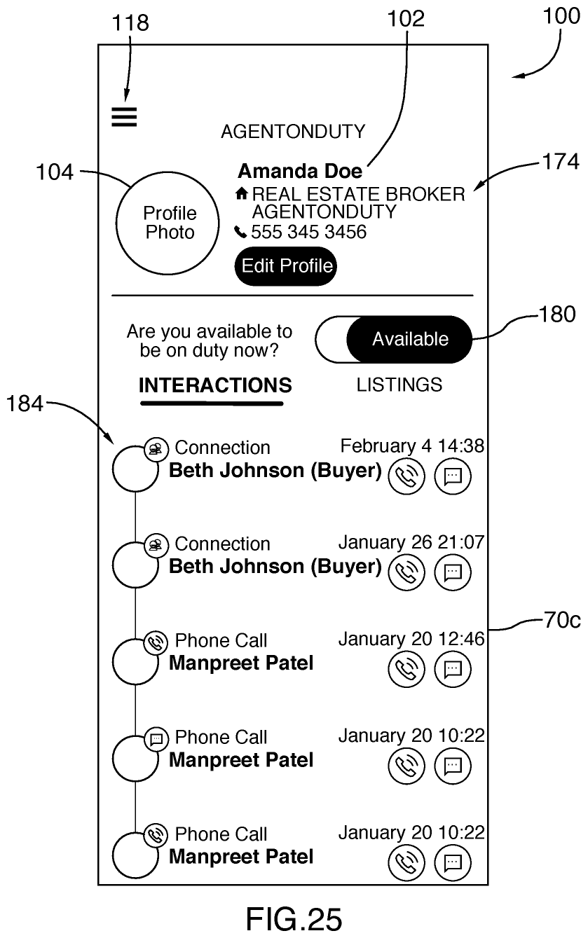

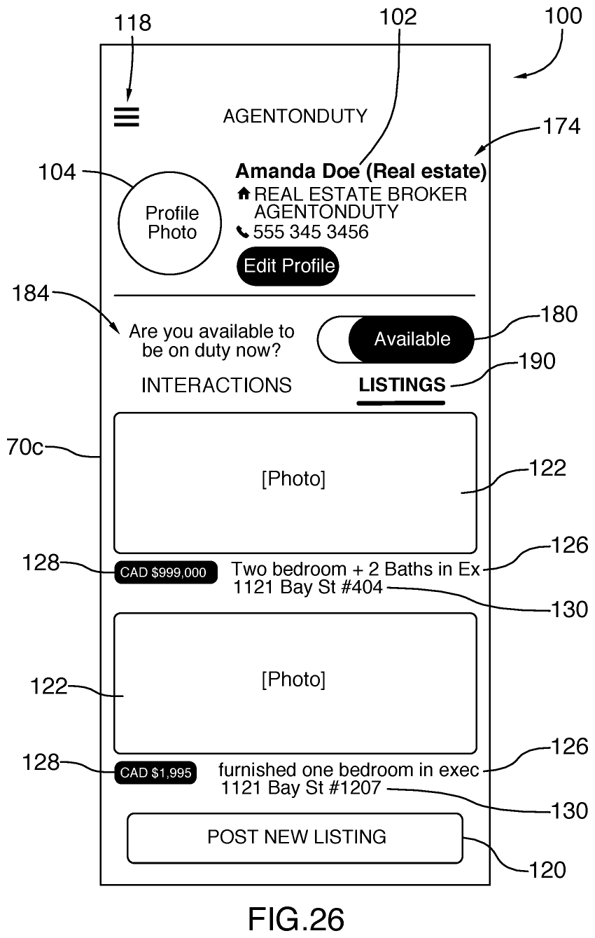

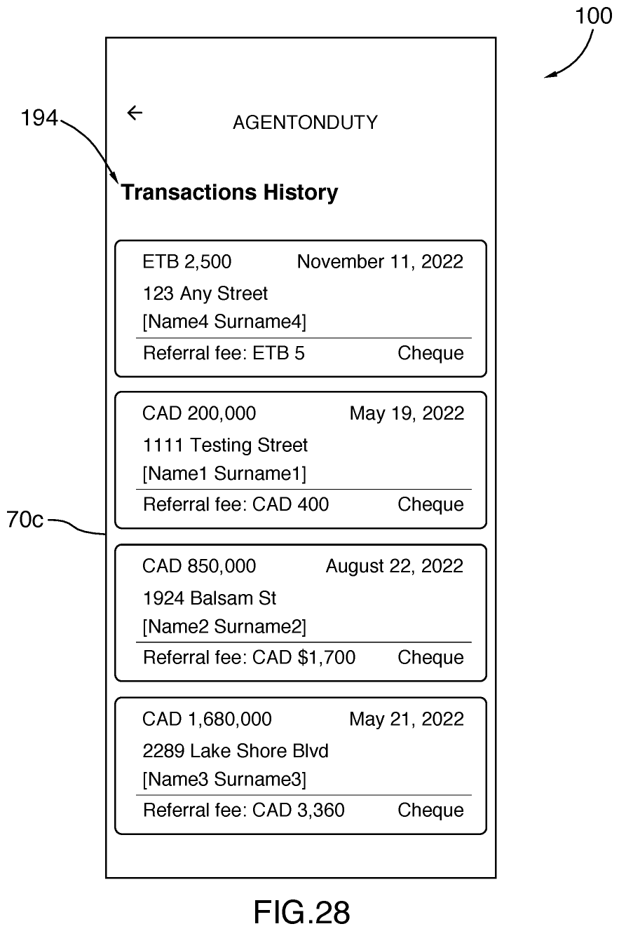

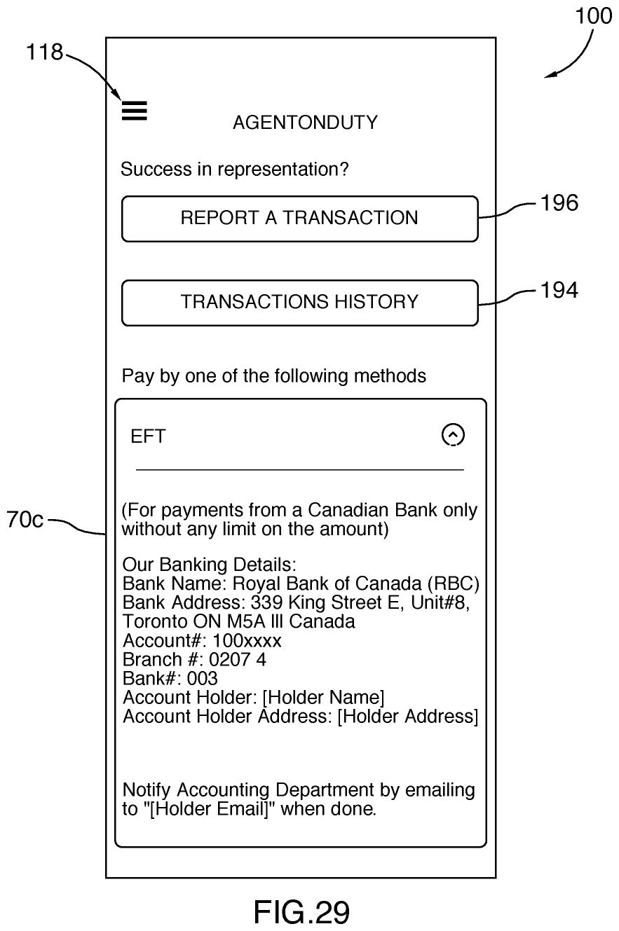

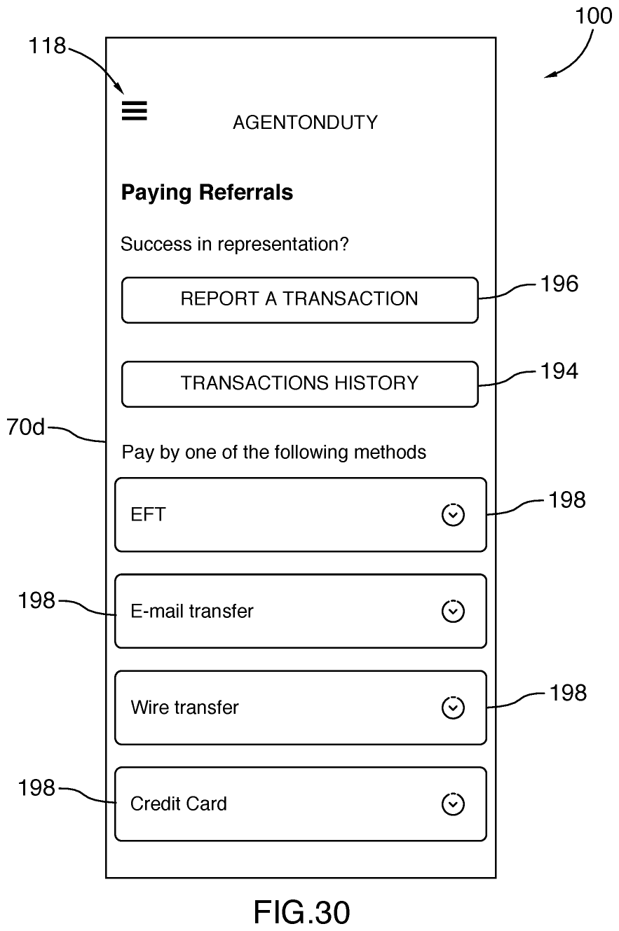

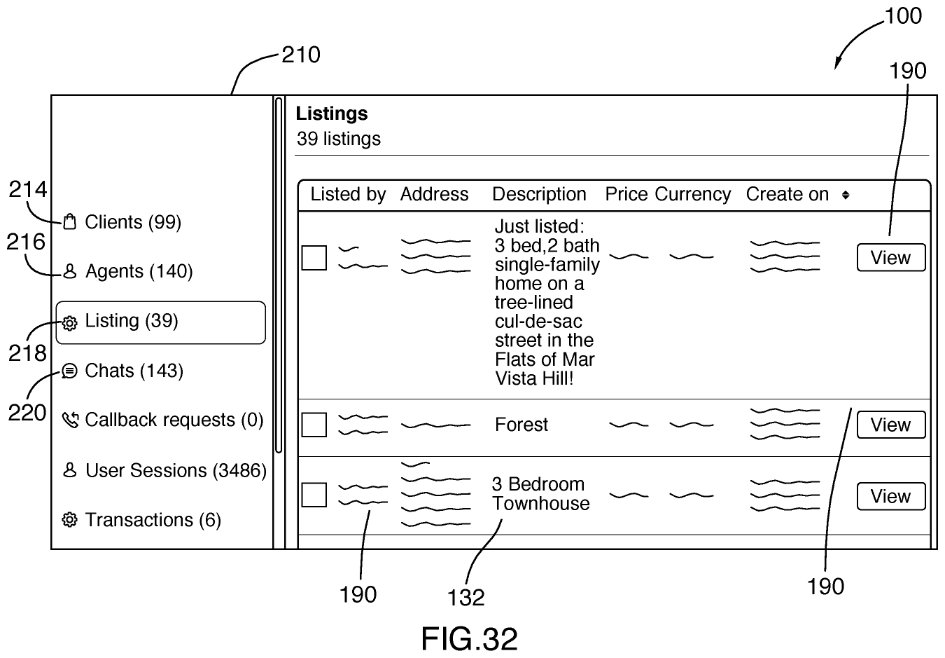

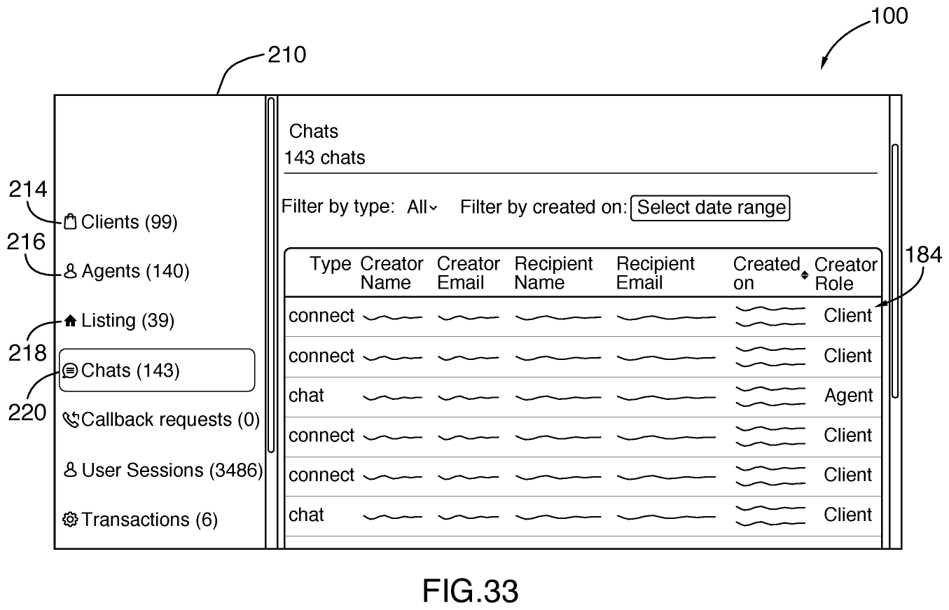

In the accompanying drawings, FIGS. 1 to 39 illustrate aspects of a real estate app 100 preferably embodied in a real estate sales device and BYOD system, method, and computer readable medium for real estate agents and clients according to the invention. Preferably, the app (or “program” or “platform” or “portal”) 100 provides one or more of the following features, elements, components, parts, and/or steps that work together: a seller side of the app 100; an agent side of the app 100; a client side of the app 100; and an administrator side 210 of the app 100. (Preferably the “client” is, in general, someone who does not post listings.) The app 100 preferably functions, perhaps at least in part, on a mobile and/or software-as-a-service (or “SaaS”) model. The app's primary users may preferably include real estate agents 60c, sellers 60a, and buyers, among others.

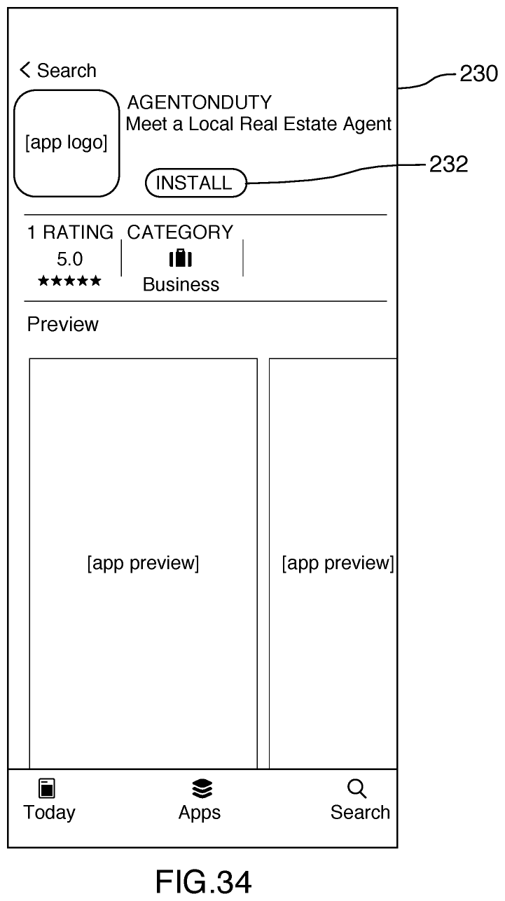

As may be best appreciated from FIG. 34, the app 100 can preferably be readily downloaded via an app store 230, e.g., Apple's App Store and/or Google Play, for installation 232 on a mobile device 70a, 70b, 70c, 70d.

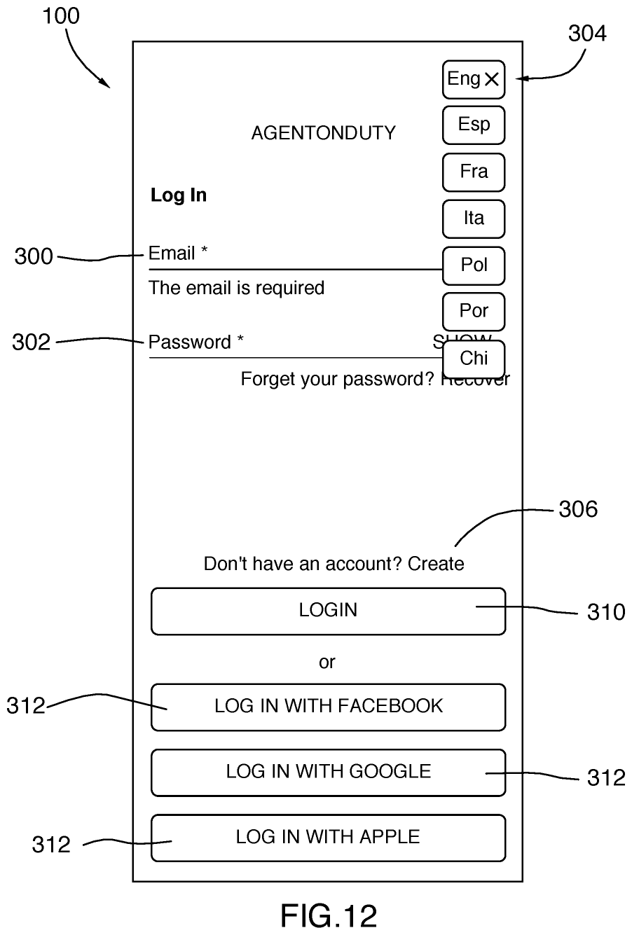

As may be best appreciated from FIG. 12, the app 100 may require an email address 300 and a password 302 as identification (or “ID”) to set up 306 or login 310 to an account. The user is preferably also afforded an opportunity to select a desired language 304 for their user interface within the app 100. The set up function 306 allows a new user to create an account within the app 100 if desired. The app 100 preferably affords users with alternate means to set up or login to an account, e.g., via an existing account with another service provider 312, such as Facebook, Google, and/or Apple.

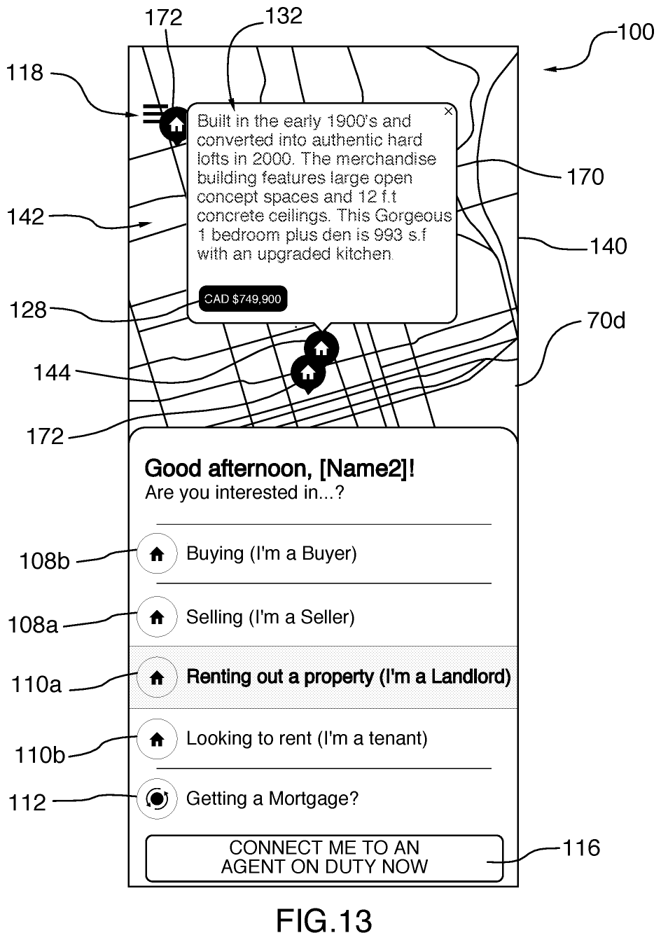

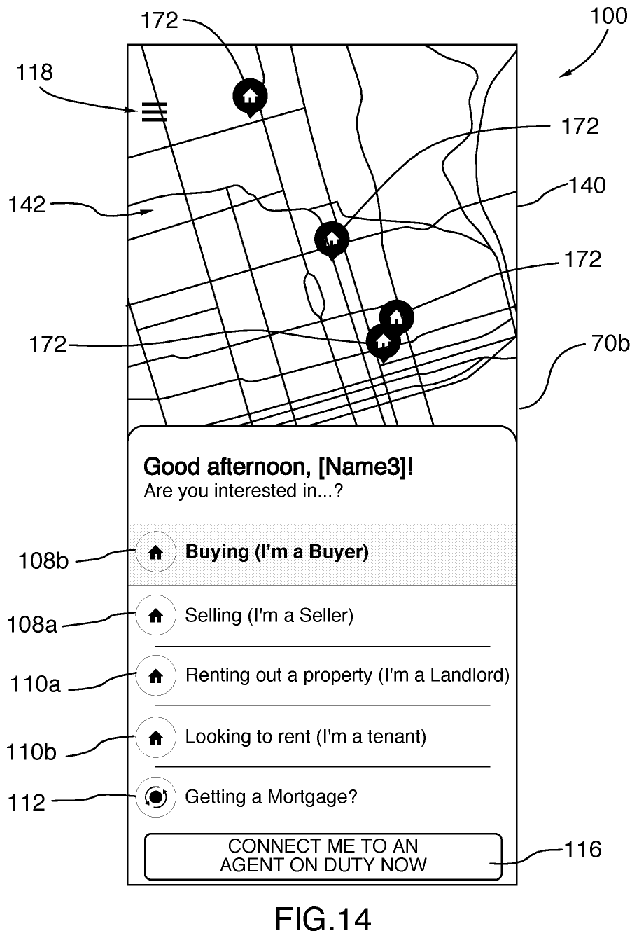

In a client side of the app 100, users are preferably presented with a map element (e.g., via Google Maps) 140 to display properties 172 for sale and/or for lease—for example, as shown in FIGS. 13 and 14. These listings 172 are preferably pulled from a MLS service or were previously inputted by a real estate agent 60c (or by a seller 60a) who has an account with the app 100.

The MLS listings are preferably pulled and populated into the app 100 using one or more APIs for interfacing with the MLS services. The APIs may, for example, be obtained through a commercial API marketplace, such as, for example, the RapidAPI marketplace. A monthly fee may be paid via the commercial API marketplace, depending on the number of API calls. The app 100 preferably first displays any “agent on duty” or “AOD” listings 172 that were previously inputted by real estate agents 60c and sellers 60a, using seller devices 70a, who have accounts with the app 100—i.e., preferably before displaying any MLS listings.

Agents 60c, using agent devices 70c, with app 100 accounts may choose to list a number (e.g., three) of their own real estate properties 172 for sale within the app 100—i.e., even though they may also be listed on an MLS service. In this way, potential clients may see these properties 172 displayed within the app 100 sooner than any MLS listings.

In a majority of countries other than Canada and the United States (i.e., in other countries where little or no MLS services are available), the local real estate listings 172 displayed within the app 100 will be principally drawn from any AOD listings and/or “for sale by owner” (or “FSBO”) listings that may have been inputted and/or entered in or for those countries.

After clients login, the app 100 preferably prompts them (as shown in FIGS. 1, 13, and 14) to indicate whether they wish to buy 108b or sell 108a a property, to rent a property as a landlord 110a or tenant 110b, or to obtain a mortgage 112. Preferably, after a client has been connected with an on-duty agent 60c using an agent device 70c, the agent device 70c will show the agent 60c what the client indicated, so they might better help the client. If the client indicated that they would like to “Get a Mortgage” 112, then the app 100 will preferably only connect them with agents 60c who chose (or indicated themselves to be a) “mortgage agent” when they signed-up/created an agent-side account within the app 100.

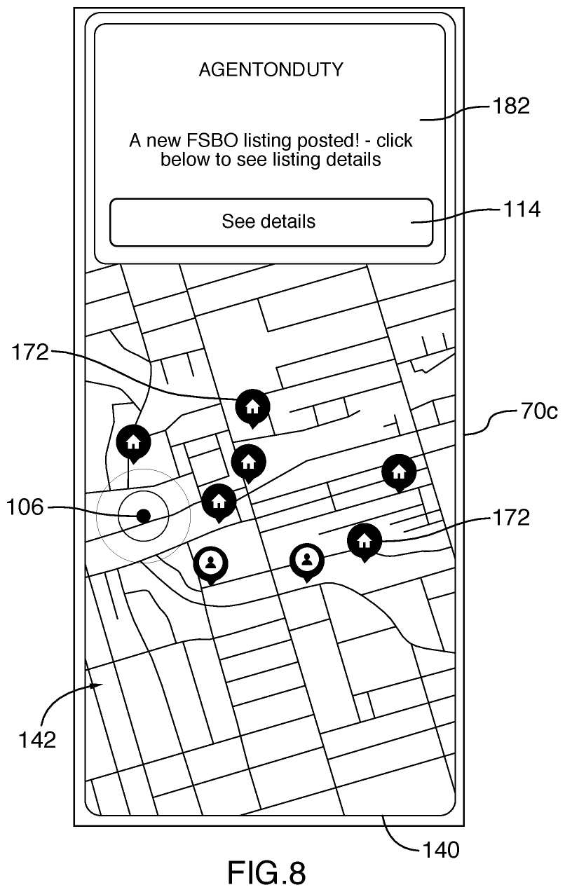

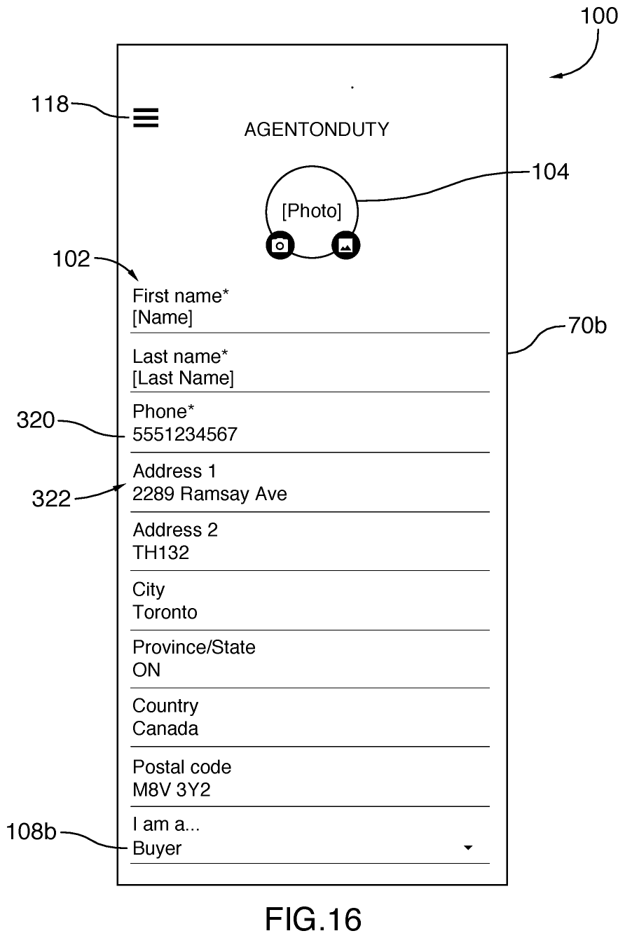

An account profile page (for example, as shown in FIG. 16) enables a user to enter a user name 102 and upload a profile photo 104. This page may be accessed via an account button 154 via a menu 150 that may itself be accessed from a menu button 118 on various screens within the app 100. The page may also be accessed via the account creation or setup button 306. It enables the user to enter their phone number 320 and address 322, among other things. In various screens within the app 100 (for example, as shown in FIGS. 1 and 8), a user's device location 106 may be pinned or otherwise depicted, relative to geographic areas 142 and property listings 172, on the map element 140.

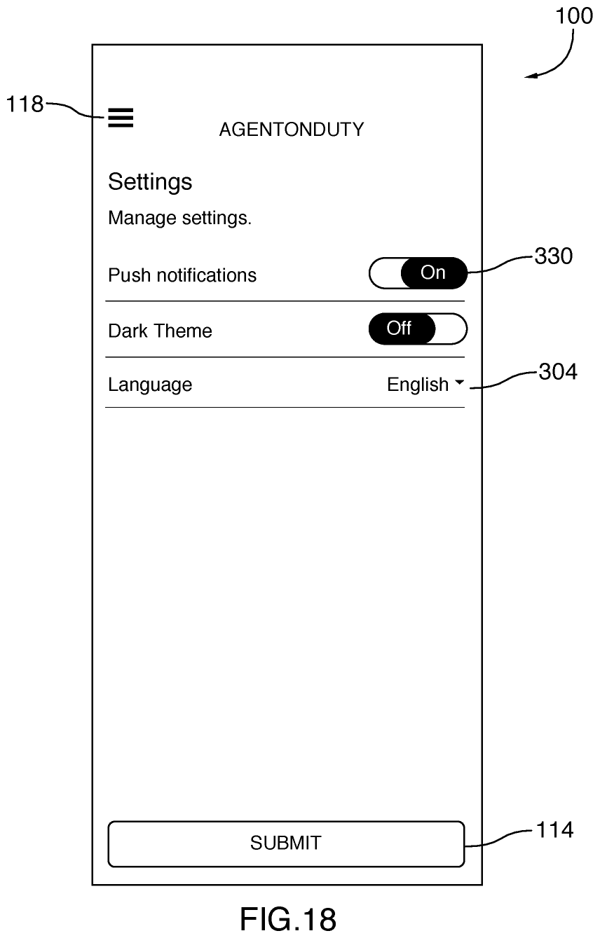

A settings screen (for example, as shown in FIG. 18) may be accessed via a settings button 164 via the menu 150. Among other things, the settings screen preferably enables the user to select their desired language 304 for their user interface within the app 100, and to select a push notifications button 330 to turn push notifications on or off, before hitting a continue or submit button 114 to exit the settings screen.

Agents 60c who use the app 100 on their agent devices 70c can preferably create or update their profile to indicate whether they are realtors, mortgage agents, or both, so they can be connected with appropriate clients. For example, as detailed in preceding paragraphs and/or elsewhere herein.

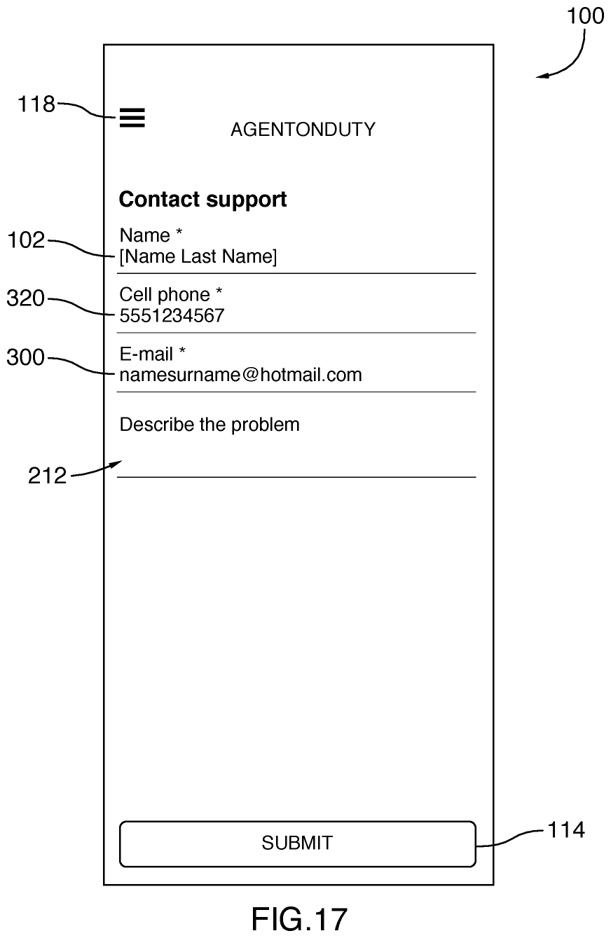

A contact support screen (for example, as shown in FIG. 17) may be accessed via a help button 162 via the menu 150. As aforesaid, the menu 150 may be accessed from a menu button 118 on various screens within the app 100. The contact support screen preferably enables the user to enter a description of their problem 212 along with their other contact information—e.g., name 102, phone number 320, and email address 322—before hitting a continue or submit button 114 to open a ticket with the help desk.

The app 100 preferably includes one or more geolocation algorithms that determine which agent devices 70c, and by extension which agents 60c, are “on duty” in proximity to and/or within a predetermined range (e.g., within 30 kilometers) of a particular client. The app 100 may preferably adjust the predetermined range in dependent relation based, e.g., on local population density, client user density, agent user density, and/or economic data. For example, the predetermined range may be smaller in areas of higher population density. The app 100 may preferably calculate a connection distance automatically, e.g., based on agent on duty numbers and/or other local economic data.

After a client asks to be connected 116 with an agent 60c, the app 100 preferably connects with an agent device 70c of an agent 60c on duty nearby. If there is an agent 60c on duty with a nearby agent device 70c, the app 100 preferably takes less than about 1 second to make the connection. If no agent 60c is on duty nearby, the app 100 preferably automatically sends a customer service email to notify the app service providers and/or administrators that a client needs a referral to find an agent 60c in a certain area.

Agents 60c can preferably use their agent devices 70c to add a predetermined number of real estate property listings (e.g., 3 listings) 172 to the app 100 using their agent account within the app 100. As described elsewhere herein, the listings 172 added to the app's inventory in this manner may be referenced herein, and handled within the app 100, as “agent on duty” or “AOD” listings 172. An address 130 for each real estate property 172 will preferably be pinned onto a Google Map 140 of the world as a geolocation 144 to be seen by users nearby that listing location 144. For example, an agent in Toronto can add a listing in New York City (or “NYC”). This NYC listing will preferably be seen by users (both clients and agents) nearby the listing in NYC. Preferably, no one in Toronto can see this listing, i.e., even though it was added by an agent in Toronto. The map element 140 also preferably displays local geographic areas 142.

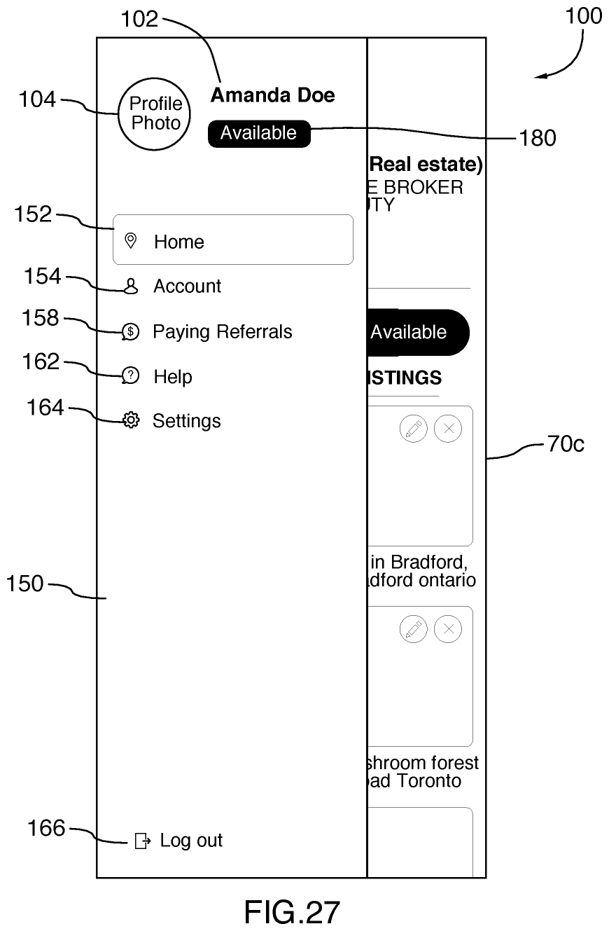

As may be appreciated in view of FIGS. 27 to 30, the app 100 may enable payment of the referral fee 134 by a payment button 198, for example, by credit card in concert with an online payment platform (such as, for example, that offered by Stripe, Inc. of San Francisco, Calif.). When an agent or listing contact 60d, using a listing contact device 70d, chooses to pay by credit card they can pay the referral fee 134 directly within the app 100.

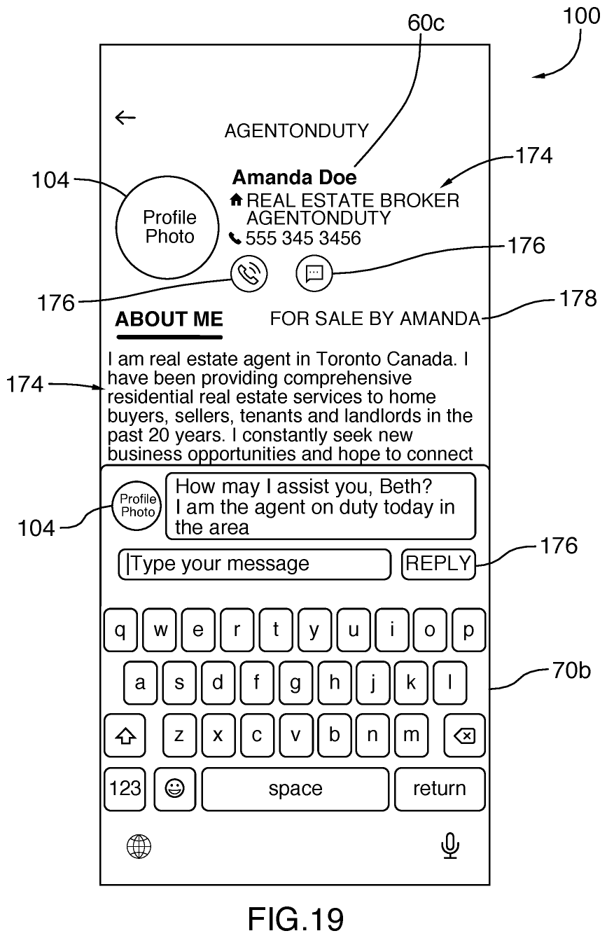

Preferably, the app 100 affords users with an in-app chat functionality 176 so that a potential client can use their device 70b to communicate with the on-duty agent 60c, who is using their agent device 70c, by video messages and/or text messages (as shown in FIG. 19).

The app 100 enables a client using their device 70b to selectively connect 176 with an on-duty agent 60c, substantially instantly. With the click of a button 176 on their device 70b, the client can preferably obtain substantially instant service that they need then (at that time) and there (where they are). In addition, the app 100 preferably connects them and their device 70b live, substantially in real-time, with an agent's device 70c and an agent 60c who are nearby. The geolocation settings for such connections may preferably be set to connect persons who are, for example, within about 30 kilometers of each other. The app 100 preferably provides agents 60c, for free, with leads on potential clients for their business “pipeline”.

The app 100 provides or embodies one or more connection algorithms that preferably enable clients to connect with agent devices 70c and real estate agents 60c from different real estate offices (e.g., at different locations, working for or under different real estate banners, companies, and/or brokerages) who are nearby. The best agent 60c for a particular client could be one who can help that client when and where they need help (e.g., an agent device 70c and an agent 60c who are in the right place, at the right time). This app's platform 100 preferably provides agents 60c with substantially equal footing to perform and/or compete for new business. If a “million dollar producer” or “number one” agent is on vacation, then that agent will not be available to assist the client. The app 100 preferably helps to put potentially meaningless titles and/or awards in context for consumers who need help. The app 100 preferably connects them with agent devices 70c and agents 60c who are “on duty” nearby. The app 100 preferably provides agents 60c with an opportunity to build business and/or growth. Afterwards, consumers will preferably have a chance to be the final judge on any with whom they may, or may not, want to do business in the end. If the consumer does not like any particular on-duty agent with whom the app 100 connected them, they can simply say “no”, move onto a next on-duty agent 60c in the app 100, and/or move with their device 70b to a different geolocation before again using the app 100 to connect with a different local area expert.

The app 100 preferably enables agents 60c to use their devices 70c to provide a short biographical statement (or “bio”) 174 that will be associated with their accounts, and visible to potential clients with whom they may connect. This bio 174 preferably provides the agent 60c with a further opportunity for free advertising to potential clients.

When the app 100 initiates a connection, it first preferably displays the agent's bio 174 on the client device 70b to the client. Afterwards, the app 100 will preferably afford the client a chance to review the agent's bio 174 on the client device 70b before they decide whether to engage in any conversation and/or further conversation 176 with the agent 60c. Preferably, the short bio 174 may be readable within a few seconds and provide the client with confidence that the agent 60c on duty is an expert in the desired local area. Alternately, the short bio 174 may suggest to the client that the “on duty” agent 60c forgot to use their device 70c to turn off the duty button 180, and/or that the client was connected in error. For example, if a Toronto agent is on vacation in Vancouver and forgot to turn off the duty button 180 within the app 100 on their device 70c, the Toronto agent may end up being connected with a client local to Vancouver. But, by displaying the Toronto agent's bio 174 via the client device 70b, the app 100 may readily enable the Vancouver client to quickly determine that the Toronto agent 60c is not local to Vancouver, nor any agent they are looking for. In any event, the app 100 preferably enables the client to simply move on to a next agent 60c, preferably without wasting any undue amount of time.

As described elsewhere herein, via the agent device 70c, the app 100 preferably enables the agent 60c to add a predetermined number (e.g., three) of their own listings 172 to the app 100, i.e., as AOD listings 172. The app 100 via the agent device 70c preferably enables the agent 60c to, in this manner, promote these AOD listings 172 within the app 100 for any seller clients 60a of the agent 60c. The app 100 enables any “on duty” real estate agents 60c with agent devices 70c nearby to these AOD listings 172 to effectively advertise the ability of these agents 60c to serve clients. These and other AOD listings 172 are preferably pinned to the map 140 and visible to agents 60c and clients (i.e., potential buyers) close to each AOD listing's location 144.

After a potential buyer clicks on a particular listing 172, the app 100 preferably uses the buyer's device 70b to display the “on duty” agent's information 174, i.e., rather than any contact information for the listing agent 60d or the seller 60a. The app 100 preferably uses the buyer's device 70b to direct the potential buyer to the “on duty” agent 60c. The app 100 then affords the “on duty” agent 60c a chance to use the app 100 running on the agent device 70c to selectively contact the listing agent 60d (or seller 60a) if they would like to show the listing to the potential buyer, and/or to confirm that the listing agent 60d (or seller 60a) will pay a commission 134 to the “on duty” agent 60c, e.g., before the “on duty” agent 60c makes any effort to sell the listing 172. There may be little, less, or no need to seek such confirmation if the listing 172 was populated to the app from a MLS service, or under another multiple agent services and/or co-broker model.

Adding an AOD listing 172 to the app 100, whether as an agent 60c using an agent device 70c or a (“for sale by owner” or “FSBO”) seller 60a using a seller device 70a, may be similar to adding a listing to an MLS service, perhaps at least in some ways. AOD listings 172 are preferably geolocation 144 based, and can preferably be seen substantially instantaneously by nearby users. In some ways, adding AOD listings 172 may be simpler than adding MLS listings (e.g., the app 100 may not require any real estate agent license to add an AOD listing 172). Yet, the app 100 may enable and provide much or all the same, and perhaps one or more better, functionalities as or than any offered by unduly and/or rigidly controlled, by-law governed, and/or exclusionary MLS systems.

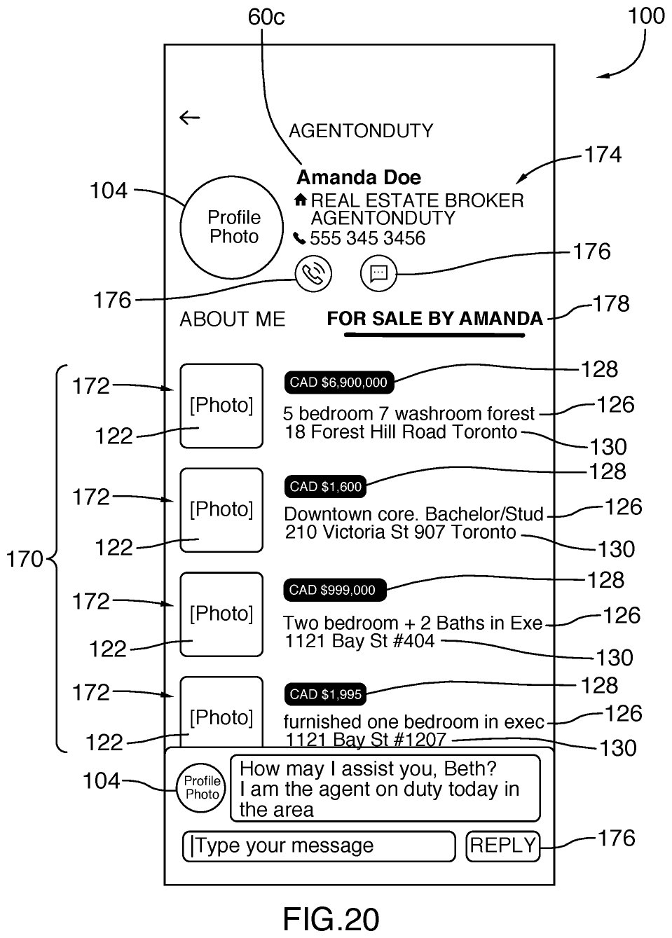

According to the invention, the app 100 preferably includes one or more geolocation based algorithms. As shown in FIG. 20, when two users (potential client and agent 60c) are connected, via their devices 70b, 70c and the app 100, the app 100 preferably generates a personalized banner 178 for the agent 60c (e.g., “For Sale by <Insert Agent's First Name>” 178) on the client device 70b and the geolocation based algorithms preferably display client listings 170, including one or more real estate listings 172, local to the potential client, under the agent's personalized banner 178. In this way, the app 100 preferably shows a number of client listings 170, including local real estate listings 172 on the client device 70b that the agent 60c might help the potential client to buy. Though, the agent 60c likely was not engaged as the listing agent 60d by the sellers 60a of these local real estate listings 172. Rather, these listings 172 likely were inputted by other AOD agents 60c and/or populated into the app 100 from local MLS listings. Preferably, the app 100 compiles and displays these listings 172 under the personalized banner 178 (e.g., “For Sale by Amanda” as shown in FIG. 20) on the client's device 70b. As such, and since these listings 172 are preferably nearby the client, the app 100 preferably helps to establish the agent 60c as a local expert in the client's eyes.

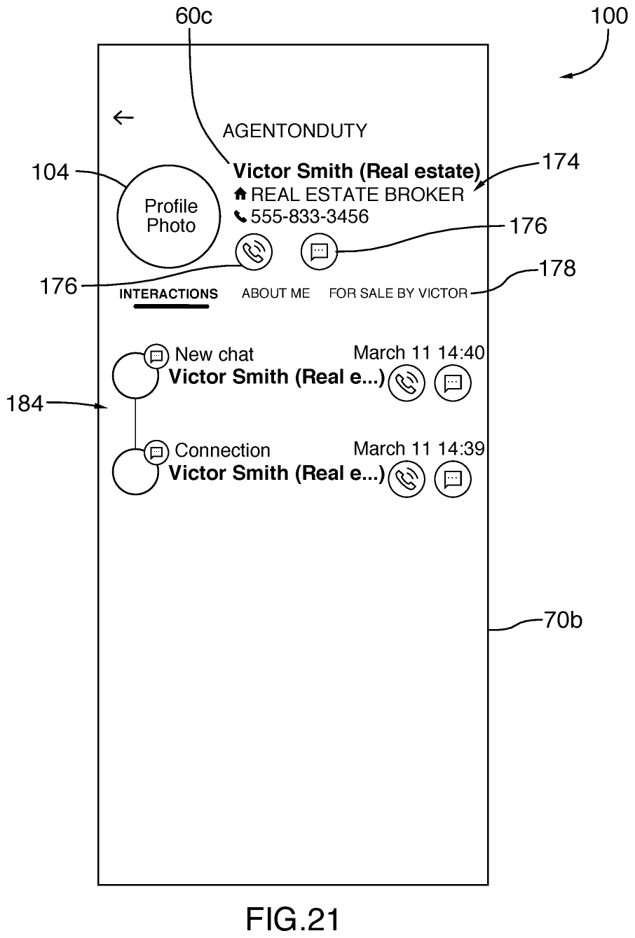

As shown in FIG. 21, the app 100 preferably displays a listing of previous interactions 184 between the clients and agents 60c on the client's device 70b. FIG. 21 depicts the interactions 184 from a client side account, on the client device 70b, and shows when they got connected to a particular agent 60c. There, the client can preferably see their past interactions 184 with the agent 60c.

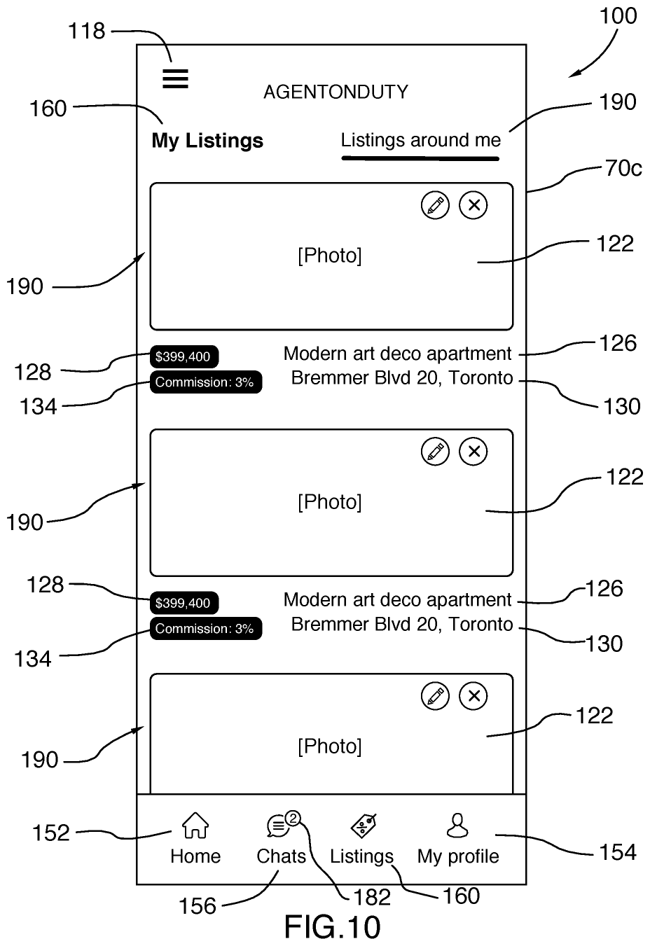

For the agent 60c, the app 100 preferably uses the geolocation based algorithms to display real estate listings 190 local to the agent on the agent device 70c, as shown in FIG. 10. Preferably, the app 100 determines which listings 190 to display to the agent 60c, perhaps at least in part depending on the proximity of the listings 190 to the agent 60c. (Rather than, depending on which listings 190 may be nearby to any clients with whom the agent 60c may be connected.) In this way, the app 100 preferably provides the agent's device 70c and the agent 60c with real estate data about the agent's immediately surrounding area. The app 100 preferably first displays a number of AOD property listings 190, followed by any FSBO (for sale by owner) listings 190, and then by any local MLS listings 190.

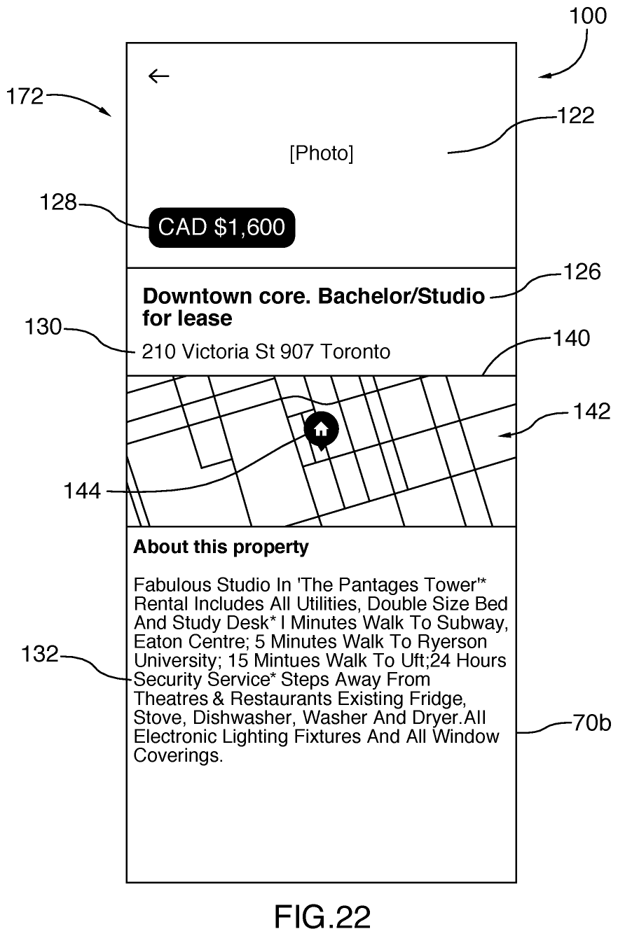

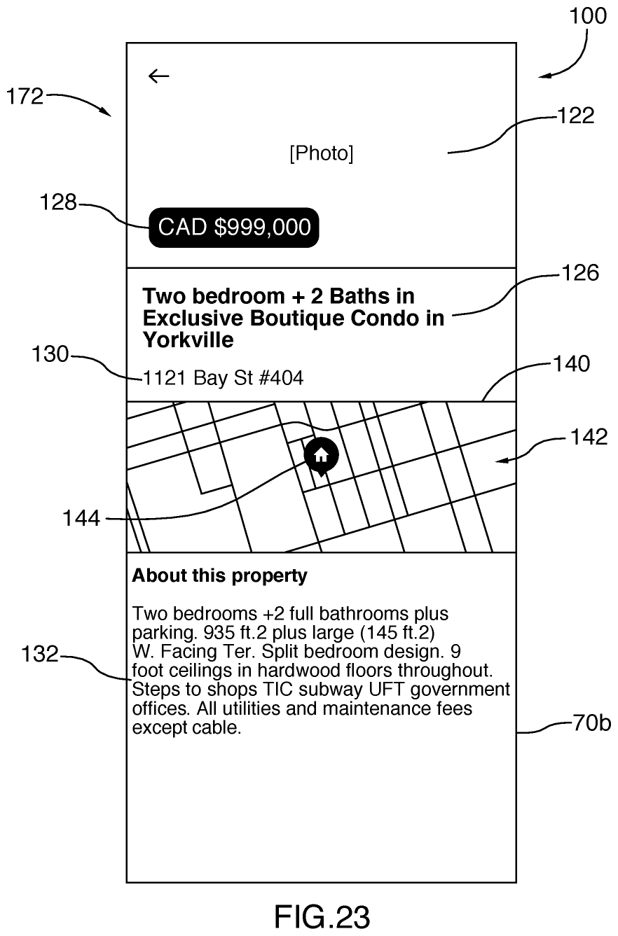

Preferably, after a potential client clicks on a listing 172 on the client device 70b (as shown in FIG. 20), the app 100 will display the property details 132 (for example, as shown in FIGS. 22 and 23). After a potential client has been connected with an “on duty” agent 60c, the app 100 preferably does not display any information about the listing agent 60d on the client device 70b. According to the invention, the client can selectively contact the “on duty” agent 60c, with whom they have been connected, should the client have any questions concerning the listing 172. In this way, the app 100 preferably helps to direct client questions (and any potential sales leads) to the “on duty” agent 60c.

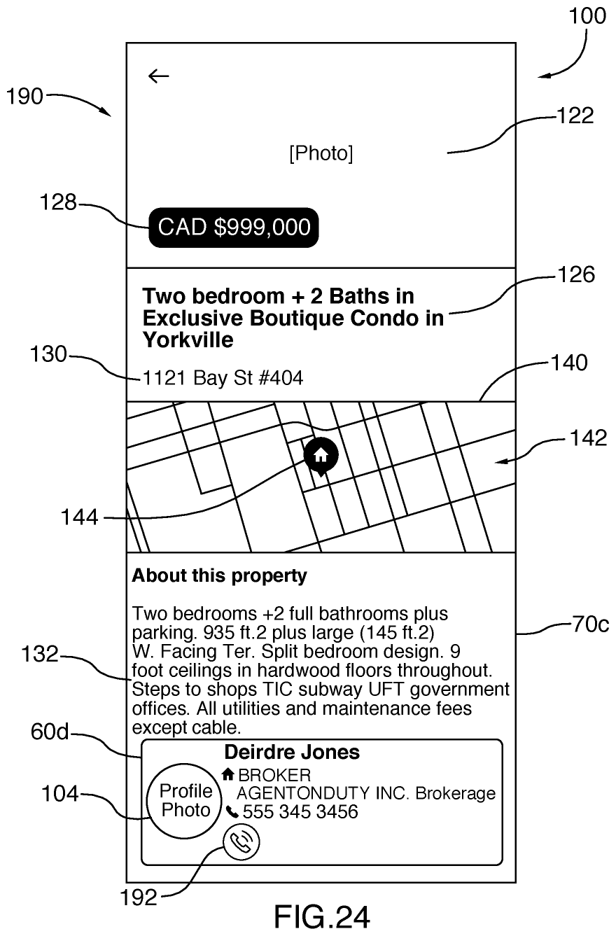

As indicated elsewhere herein, the app 100 may preferably display different listings to the agent 60c (via the agent device 70c) and to the potential client (via the client device 70b), e.g, depending on their different respective locations. According to the invention, the app 100 also displays different information to the potential client (via the client device 70b) and to the “on duty” agent 60c (via the agent device) concerning the listings 172, 190, as may be appreciated in view of FIGS. 23 and 24. As shown in FIG. 23, the app 100 preferably does not display any information concerning the property's listing agent 60d to the client on the client device 70b. Whereas, as shown in FIG. 24, the app 100 preferably displays the listing agent's contact information 60d on the agent device 70c to the “on duty” agent 60c. The app 100 preferably also includes means for the “on duty” agent 60c to, via the agent device 70c, directly contact 192 the listing agent 60d from within the app 100. One or more of these features preferably enable and/or help “on duty” agents 60c to co-broker property sales with listing agents 60d.

The app 100 preferably enables and/or helps homeowners 60a to use their devices 70a to post their own listings 172 to share among local agents 60c near the property's location 144. Buyers won't be able to see the homeowner's/seller's contact information 192 when they review the details of the listing 172. Only agents 60c will be able to see the seller's/homeowner's contact information 192 when they see listings 190 from their account. Such homeowners 60a will preferably only pay one agent fee 134, e.g., to the “on duty” agent 60c who helps sell the property. Whereas, prior art MLS systems may have required homeowners to pay a listing agent in addition to the buyer's agent (e.g., paying double the commission fees). According to the invention, if a seller 60a prefers not to handle the listing side themselves, then the seller 60a can still hire a real estate agent 60d. The app 100 preferably helps real estate agents with one or more aspects of a real estate offering and/or transaction, while still providing a seller 60a an option to work alongside a real estate agent.

According to the invention, the app 100 preferably does not require a user to have a real estate license to create an agent's account. The app 100 preferably enables and/or helps home sellers and/or landlords 60a to use their own devices 70a to list their real estate properties in the same portal as listing real estate agents alongside their property listings 172. The app 100 is preferably scalable to include (residential and commercial) real estate listings in and from all over the world. In this way, the app 100 preferably helps to create a consolidated and/or comprehensive single database of global (residential and/or commercial) real estate listings and/or inventory. According to the invention, this database may preferably help to enable, provide, and/or afford one or more further advantageous utilities of its own.

With its AOD listings 172, the app 100 preferably enables and/or helps agents in foreign countries (e.g., outside the United States and Canada) to co-broke and/or sell real estate properties relatively quickly and/or substantially quicker than in the prior art, and/or to increase and/or maximize exposure for their real estate properties. The app 100 preferably provides an easy, simple, and/or smart system that, e.g., preferably affords one or more advantages over prior art MLS systems.

The app 100 is preferably geolocation based. The listings inventory that may be added and/or accessed via the app 100 is preferably global. The app 100 and/or its data are preferably not constrained by boundaries of any real estate boards. Use of the app 100 is preferably open to the public. The app 100 may preferably enable and/or help in the compilation of a large (perhaps even the largest) worldwide real estate listing portal. The app 100 preferably receives, generates, and/or displays data that is organic, stemming from inputs volunteered by home sellers 60a and/or real estate agents 60d.

The app 100 preferably does not use listings 172 to generate leads (at least not in some of the prior art ways). The listings 172 are preferably real time based. The app 100 preferably does not require or provide any incentive to maintain any listings as “live” after they have been sold. Whereas, prior art “Sold—For Sale” signs may have been used for lead generation. (For example, after “Sold” signs were displayed on properties, they may have enabled and/or helped listing agents to receive more calls from the neighborhood as new leads.) The app 100 preferably receives and/or displays listings 172 to enable and/or help in finding potential buyers—rather than, e.g., to help listing agents 60d get leads. The app 100 preferably enables and/or helps in replacing, removing, limiting, reducing, and/or doing away with any need for “Sold” and/or “For Sale” signs, e.g., on the front lawn.

The app 100 preferably records and/or stores user connection history 184, e.g., in both the client's and agent's accounts for display on client devices 70b and agent devices 70c respectively. Preferably, if a user misses a connection, the user can review the connection history 184 in their account to locate and review any connections that may be sought. Preferably, the user can use the app's in-app chat 156 features, for free, to connect and/or reconnect—preferably, without needing to share or know each other's contact information (e.g., phone number 320 and/or email address 300).

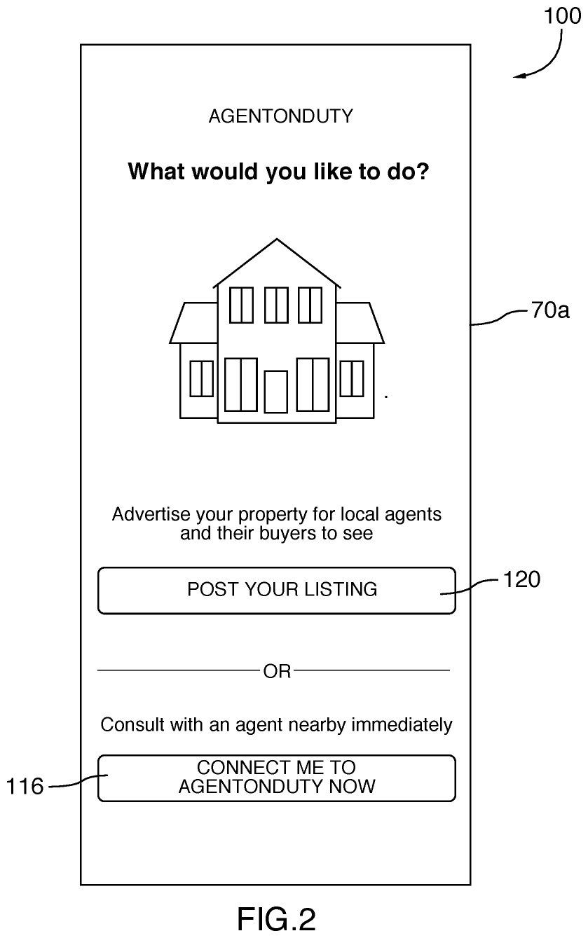

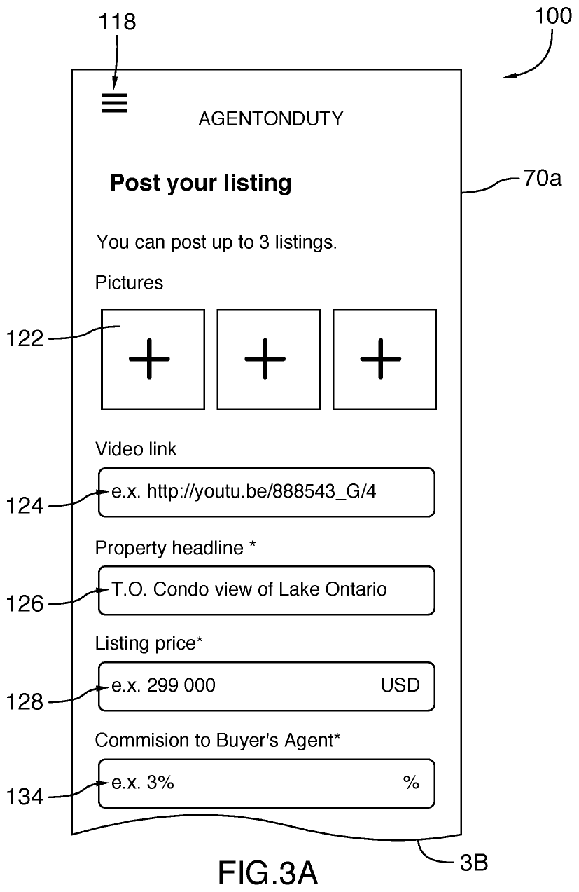

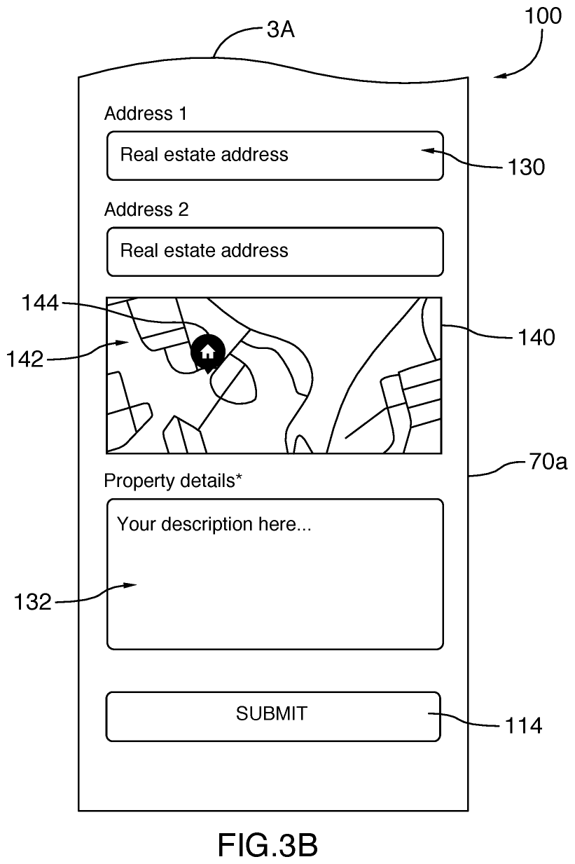

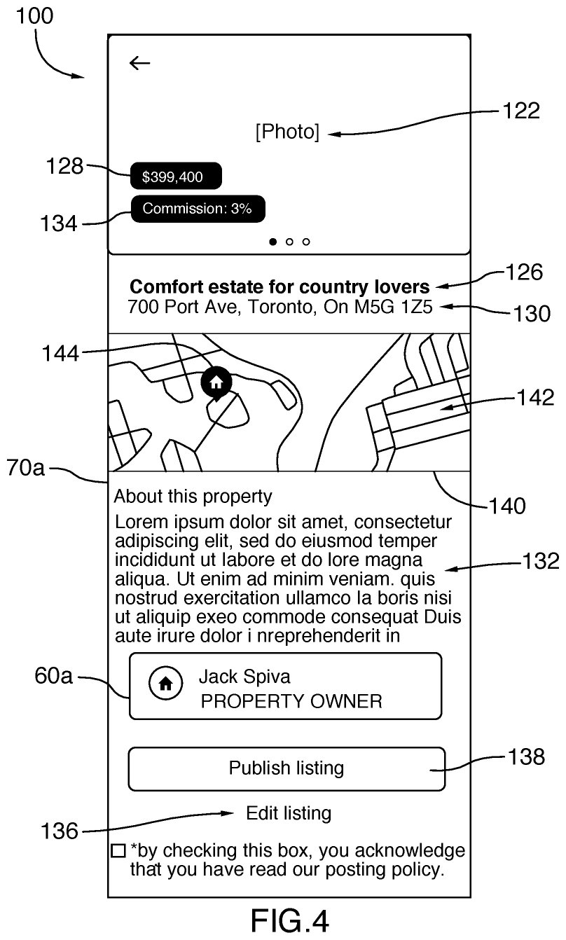

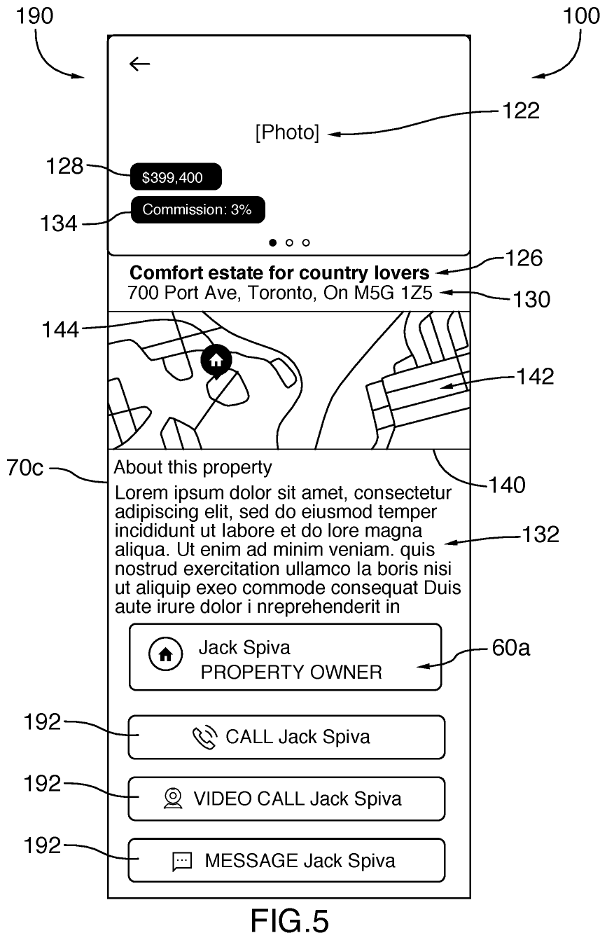

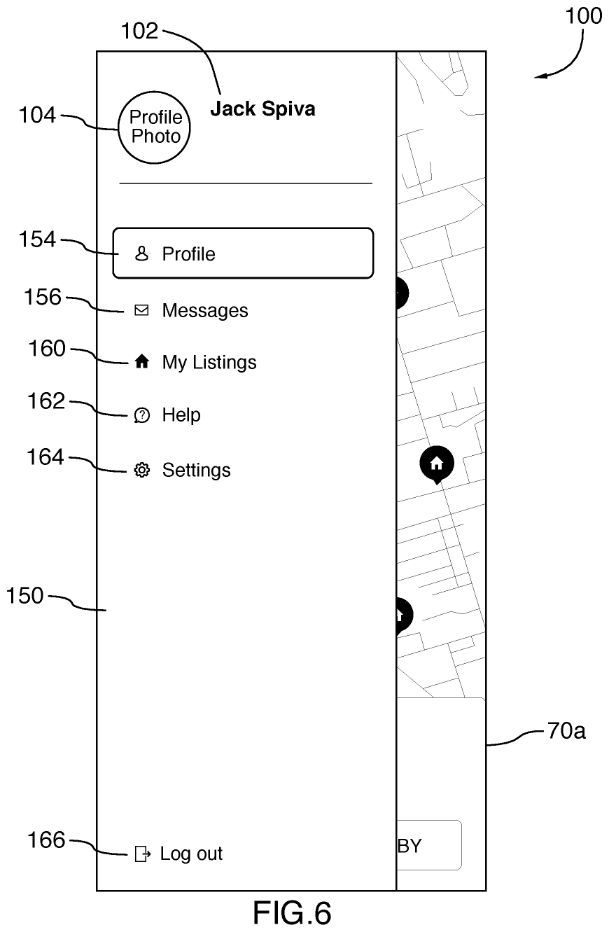

As shown in FIGS. 1 to 4, in listing FSBO properties, sellers and/or landlords 60a can use their devices 70a to readily navigate through a series of screens displayed by the app 100, e.g., when they wish to sell or rent out their properties. In a FSBO section, the app 100 preferably prompts the seller and/or landlord 60a, via their device 70a, to either (A) post 120 details of any property they might want to offer, or (B) connect 116 with an “on duty” agent 60c in a standard mode, as shown in FIG. 2. After a seller 60a selects option (A) above, the app 100 preferably uses the seller device 70a to present the seller 60a with a posting form (as shown in FIGS. 3A and 3B) where the seller 60a can selectively enter property data—e.g., listing photos 122, property headlines 126, listing price 128, address 130, property details 132, location 144—and/or a link to a video 124 to view the property, and/or set a commission 134 for the “on duty” agent 60c who helps to complete the real estate transaction. As shown in FIG. 4, the app 100 running on the seller device 70a preferably enables the seller 60a to subsequently verify and/or confirm the accuracy and completeness of all the listing information that was entered, before enabling the seller to selectively post 138 the listing when it is ready to go. FIG. 5 depicts details of how the app 100 preferably presents a FSBO listing 190 via an agent device 70c to an agent 60c. FIG. 6 depicts how the app 100 running on the seller device 70a preferably enables the seller 60a to access their listing 160 from a menu 150 during later use of the app 100.

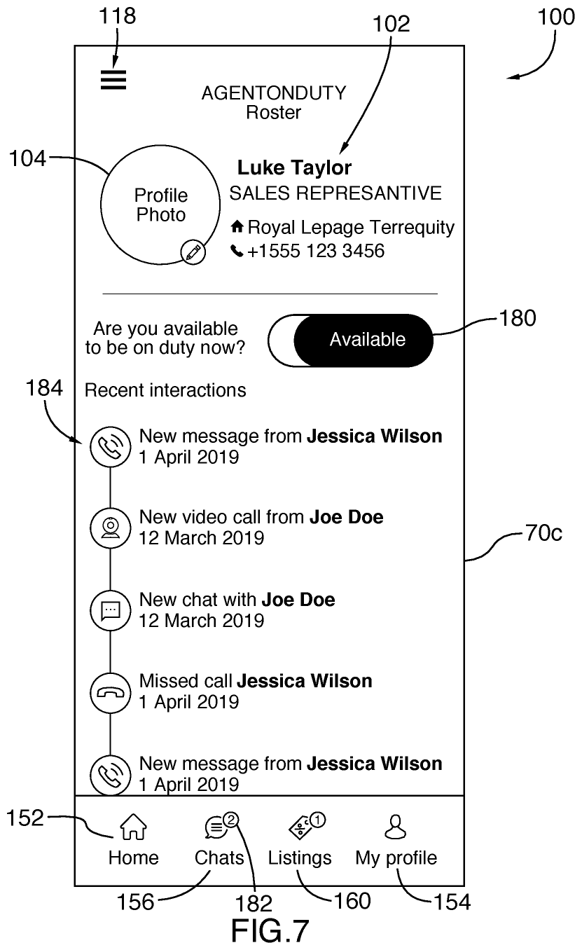

FIGS. 7 to 11 depict how the app 100 preferably uses the agent devices 70c to notify agents with accounts in the app 100 of new FSBO listings 172 that are being posted. As shown in FIG. 7, the app 100 may push and/or display a notification symbol adjacent to a “Listings” button 160 in the agent's interface within the app 100 running on the agent device 70c. Preferably, for example, after the agent clicks on the “Listings” notification 160, the app 100 preferably displays a push notification 182 concerning the new FSBO listing 172 (as shown in FIG. 8). As shown in FIG. 10, the app 100 will preferably display the new FSBO listing 190 in the agent's “Listings Around Me” (local listings) section 190 of the app 100 running on the agent device 70c. [Aside: For other sellers and/or potential clients, the app 100 will preferably display the new FSBO listing 172 in the user's “For Sale by <Insert On-Duty Agent's First Name>” section 178 of the app 100.]

The FSBO features of the app 100 preferably allow sellers and/or landlords 60a to use their own devices 70a to post their own properties in the app 100 for sale and/or lease. The FSBO listings 172 will preferably be pinned to the map 140, together with the AOD listings 172 and the MLS listings 172, for buyers and agents on duty to see. FSBO sellers 60a preferably only pay the on-duty agent's (i.e., the buyer's agent's) commission 134. FSBO sellers 60a preferably list their own properties and/or save half the commission that they might otherwise be required to pay. For example, in the Toronto area, FSBO sellers 60a may only be required to pay about 2.5% in commissions rather than about 5%.

In the prior art, a FSBO seller may have hired a discount real estate brokerage to merely list their property on a MLS service. Some discount real estate brokerages may typically have charged the seller a fixed amount (e.g., perhaps about $1,500-5,000) to list their property on the MLS service. Then, the FSBO seller may have been required to manage all showing appointments and/or to negotiate with the buyer's agent for the buyer's agent's commission. Typically, the FSBO seller would have still paid at least the standard/market-rate commission (e.g., of perhaps about 2.5%) to the buyer's agent, plus the fixed amount that they were charged by the discount brokerage. With this app 100, it is free for FSBO sellers 60a to use their devices 70a to advertise (i.e., list) properties 172 for nearby agents to see. They will preferably save paying any fixed amount to a discount brokerage and any commission to a seller's agent. In this way, the app 100 may provide potential buyers and agents with greater access to more listings.

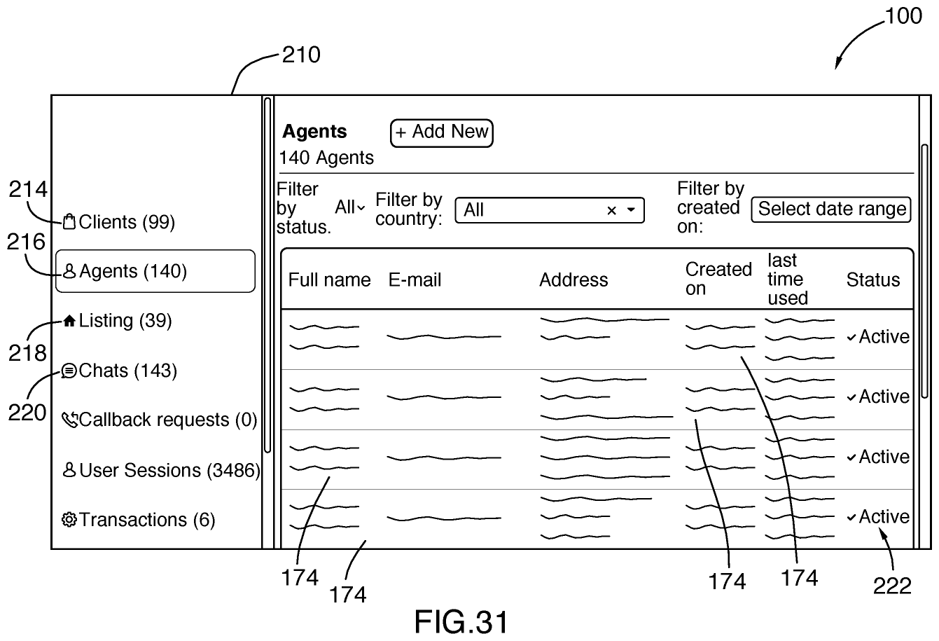

As shown in FIGS. 31 to 33, the app 100 preferably displays and/or presents numerous app performance statistics and/or data, via an administrative backend 210, for one or more service providers and/or administrators of the app 100. The app performance statistics and/or data may preferably include, for example, how many users from agents 216 and clients 214, what is any particular agent's status 222, how many connections 220 have been made, the number of listings 218, and/or the number of user sessions, etc.

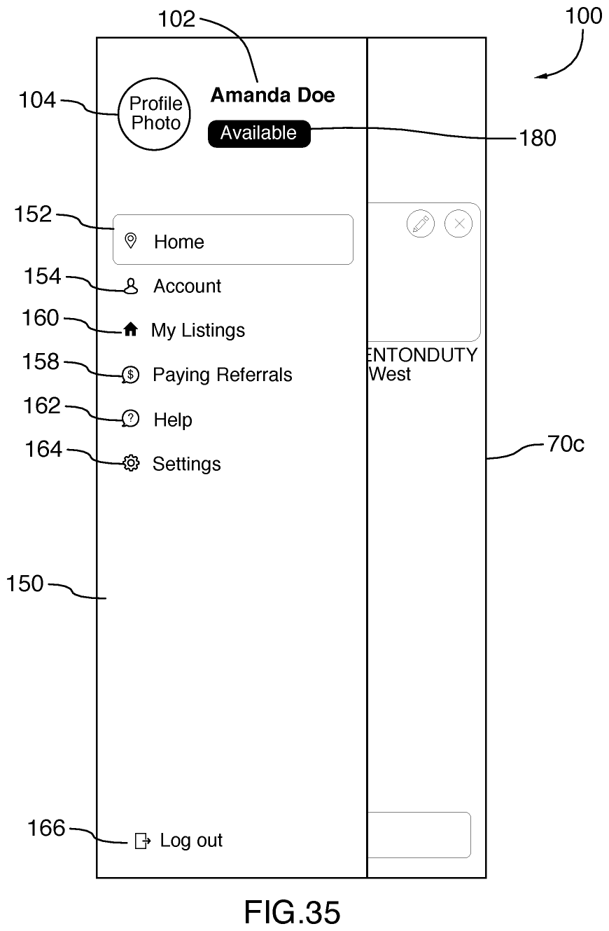

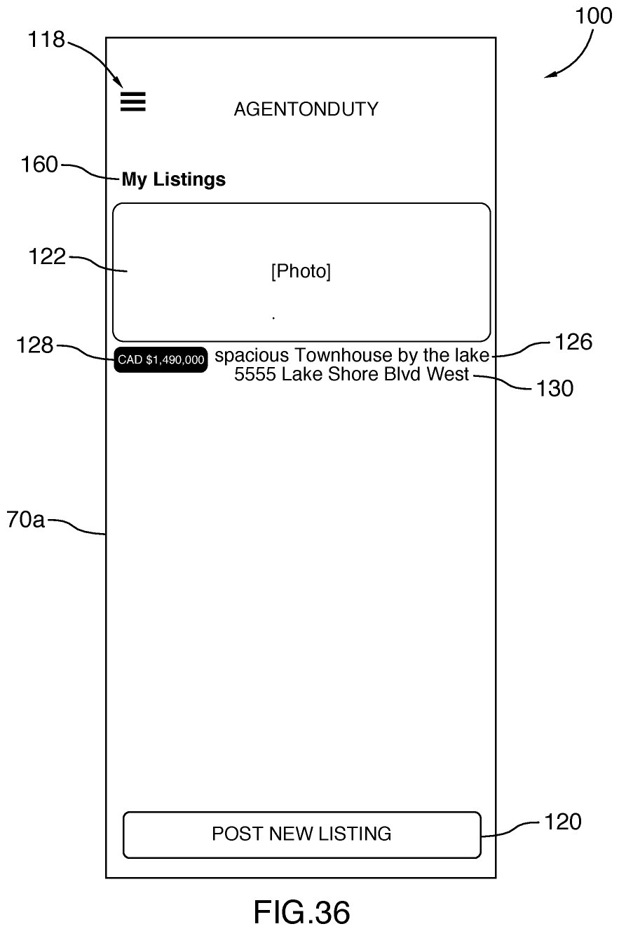

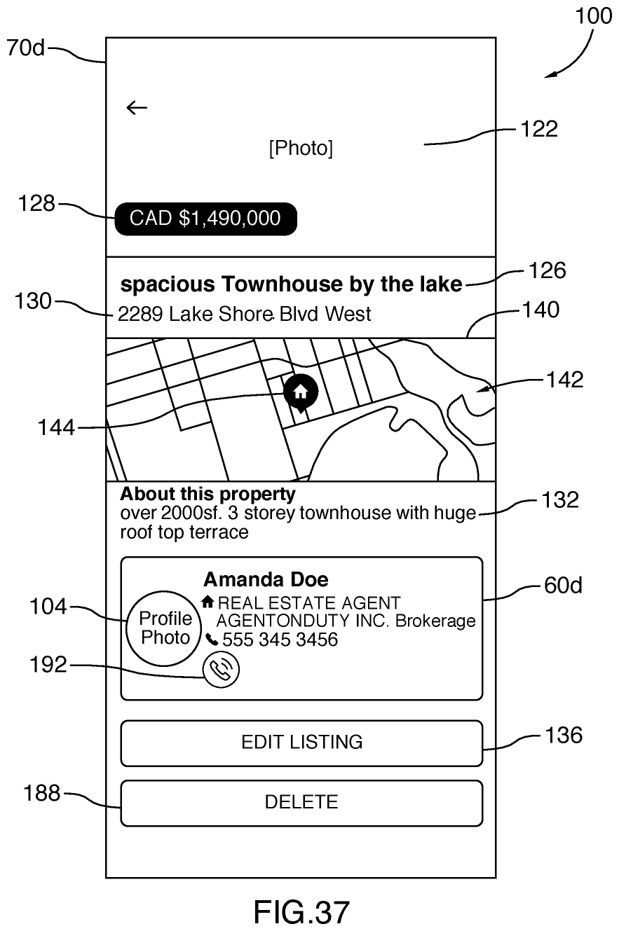

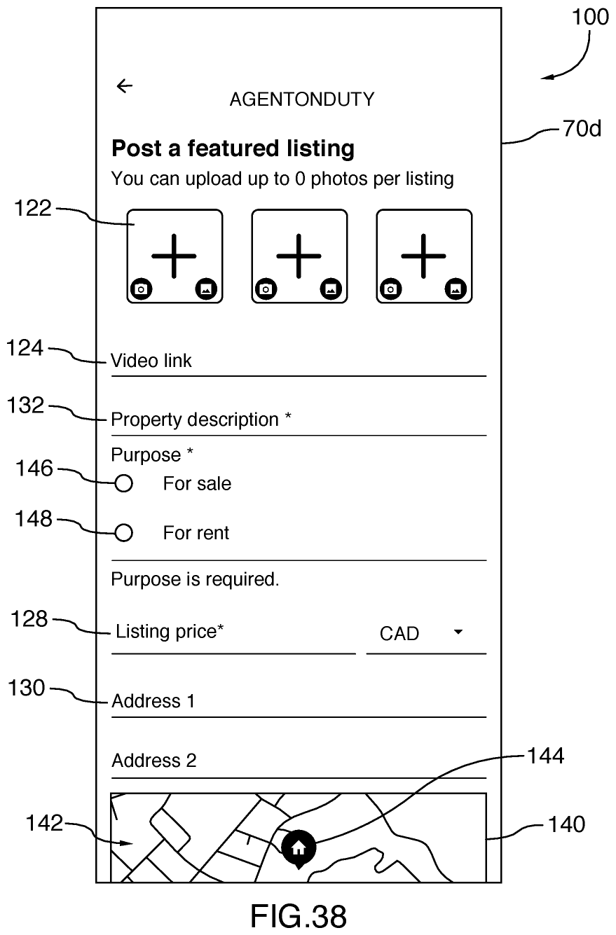

Additionally or instead, in some preferred embodiments:
The app 100 preferably uses the agent devices 70c to present agents with a menu 150 that includes a Home button 152, an Account button 154, a “My Listings” menu item 160, a Paying Referrals button 158, a Help button 162, a Settings button, and a Logout button 166, all as shown in FIG. 35 (and in various other figures). This menu 150 may preferably be accessed by using the menu button 118 that is presented in various different screens within the app 100. The app 100 preferably enables and/or facilitates agents 60d, by accessing the “My Listings” menu item 160, to easily track how many listings they have posted (as shown in FIG. 36) and/or to edit 136 the listings (as shown in FIG. 37).
The app 100 preferably enables agents 60d to post/advertise 120 as many of their own listings as they desire, without limitation. That is, in some preferred embodiments, agents 60d will preferably not be limited to a maximum of 3 listings in the app 100, and an agent 60d may preferably have no maximum number of listings that he or she can post/advertise within the app 100 from his/her account.
The app 100 running on the listing contact devices 70d preferably presents agents and listing contacts 60d with a video/virtual link 124 feature (as shown in FIG. 38). The app also enables listing contacts to indicate whether the property is for sale 146 or for rent 148. The app 100 preferably enables and/or facilitates agents or listing contacts 60d, by accessing the video/virtual link 124 feature, to add/post virtual tours that are associated with their listings within the app 100. And/or,
The app 100 running on seller devices 70a preferably enables sellers 60a to post/advertise as many listings as they have, without limitation. That is, in some preferred embodiments, sellers 60a can preferably post/advertise an unlimited number of listings for sale. Sellers/buyers can preferably, however, still only connect to agents 60c on duty. Preferably, buyers can't directly connect with sellers 60a regarding their posted listings.

FIG. 35 depicts how, additionally or instead in some preferred embodiments, the app 100 is now preferably provided with a “My Listings” menu item 160 in agents' accounts. With this menu item 160, agents 60c can preferably track how many listings they add to the system 100, and they can also preferably edit and/or change 136 their listings as they wish (as shown in FIG. 37). In these preferred embodiments, there is preferably no limit for agents to add listings into the app 100.

FIG. 36 depicts a screen that the app 100 running on the agent device 70c preferably presents after an agent clicks on the “My Listings” menu item 160. For example, this agent added one listing as shown in FIG. 36.

FIG. 37 shows how the app 100 running on the listing contact device 70d preferably presents the agent or listing contact 60d with a depiction of how their listing appears, in detail. The app 100 and its presentation of this detail preferably enables and/or facilitates agents and listing contacts to edit 136, delete 188, or modify (etc.) any details associated with each listing.

As aforesaid, in some preferred embodiments, the app 100 preferably enables agents to post/advertise as many of their own listings as they desire, without limitation. That is, agents will preferably not be limited to a maximum of 3 listings in the app 100, and an agent may preferably have no maximum number of listings that he or she can post/advertise within the app 100 from his/her account.

That said, the app 100 may preferably still enable the agent to include three photos 122 in association with each listing, as shown in FIG. 38.

As aforesaid, the app 100 preferably presents agents with a video/virtual link feature 124. The app preferably enables and/or facilitates agents, by accessing this video/virtual link feature 124, to add/post virtual tours that are associated with their listings within the app 100. By providing this video link 124 for a listing, the app 100 preferably enables and/or facilitates agents to showcase properties not only by three photos 122 but also with virtual tours 124.

FIG. 14 depicts a home screen that the app 100 running on the client device 70b preferably presents to a client when he or she logs-in the app 100. If the client logs-in as a buyer 108b, tenant 110b, or seeking a mortgage 112 (rather than as a seller 108a or landlord 110a), then the app 100 will preferably present the client with an option to “Connect Me to an Agent On Duty” now 116 as the only next button that they might click on to continue.

On the other hand, if a client logs-in as a seller 108a or landlord 110a, then the app will preferably present them with a next screen that enables them to selectively post listings 120, as shown in FIG. 2.

FIG. 1 depicts how, after a user chooses “Selling” 108a, the app 100 running on the seller device 70a preferably now presents the user with a “Continue” button 114 (e.g., instead of any “Connect Me to an Agent On Duty” button 116).

FIG. 2 depicts how, after a seller or landlord clicks the “Continue” button 114, the app 100 running on the seller or landlord device 70a preferably provides the seller or landlord with an option to selectively post any listings 120.

FIG. 38 depicts how, after a seller or landlord chooses to post listings 120, the app 100 running on their device 70d preferably presents them with a screen which enables and/or facilitates their addition of three photos 122.

The app 100 preferably also enables and/or facilitates their insertion of a URL as a link to a video 124 that might preferably feature 3D tours, and more photos, etc.

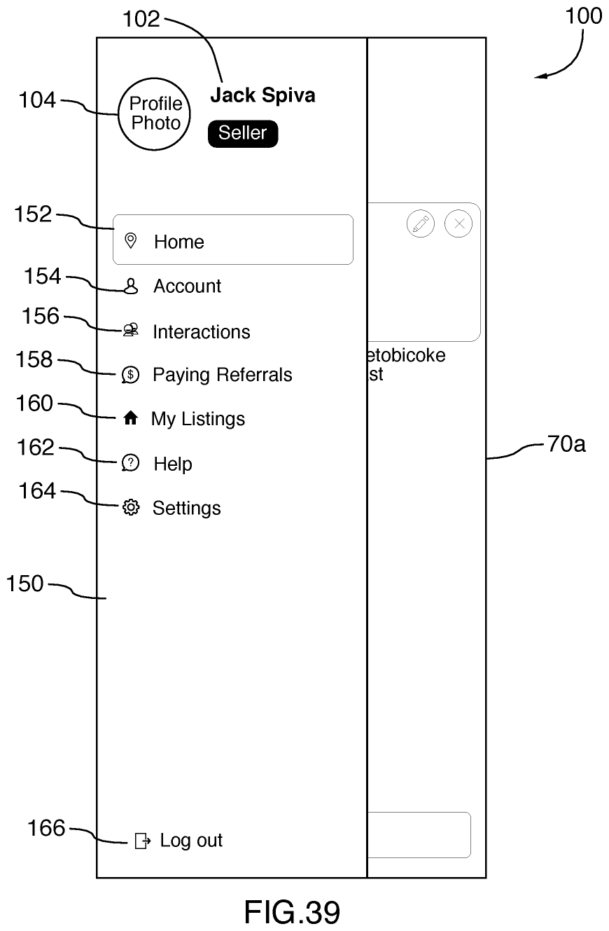

FIG. 39 depicts how the app may preferably also then add a “My Listings” menu item 160 to such a client's account. In this way, the app 100 preferably enables and/or facilitates a client who is a seller (FSBO—for sale by owner) to add listings and/or to edit them.

According to the invention, the app 100 preferably embodies one or more novel methods and/or systems, as described herein. The app 100 preferably enables and/or helps agents and homeowners to post and sell real estate listings 172 via the same platform as one another. Preferably, the app 100 connects a potential real estate client with an “on duty” agent 60c, and directs the potential client and provides a lead for a potential real estate transaction to the “on duty” agent 60c who was connected with the client. (Rather than, e.g., to the seller and/or listing agent who added the listing.) The app 100 preferably enables and/or helps with removal of one or more obstacles to finding buyers/tenants for sellers and/or listing agents. The app 100 preferably makes all local listings accessible to local buyers. The app 100 preferably does not replace real estate agents services. The app 100 preferably enables and/or helps give a seller an opportunity to pay only a buyer side commission, e.g., if they want to be their own listing agent and do any and all the work on the listing and/or marketing side.

In the prior art, licensed agents and home sellers may have advertised their properties for sale in an effort to generate leads for potential sales. Agents who did not have their own listings may have been limited in their ability to generate any such leads. Such agents may have instead spent money to advertise themselves—e.g., on billboards and park benches, and via social media, search engine optimization (or “SEO”), and websites, etc.

The app 100 preferably enables and/or helps with compilation and/or display of MLS listings and FSBO listings 172 on one platform, preferably enabling and/or helping with compilation of a comprehensive listing of more available real estate inventory.

The app 100 preferably works with localized connections and yet can be used globally. For example, the app 100 preferably works with local sales, local listings, and local connections. Yet, the app 100 can preferably be used in any country where real estate transactions may occur. According to the invention, the app 100 preferably embodies this new system, method, and/or model, e.g., to facilitate real estate transactions.

The app 100 preferably enables and/or helps with sharing of “on duty” agent rosters, e.g., by enabling any and all agents to login from anywhere and whenever they like. The app 100 preferably uses this data to generate an “organic” roster for the benefit of potential clients whenever and wherever they need to connect with an on-duty agent. This app 100 preferably enables and/or helps with generation of a large (perhaps the largest) online roster of on-duty agents worldwide, while still enabling those agents to help their local communities where and when they choose.

The app 100 preferably helps sellers and/or listing agents to disclose (and on-duty agents helping the buyer to receive) referral payment information in advance and/or to simplify one or more real estate referral processes.

In use, the app 100 preferably enables and/or helps: (A) establish when a service party is “on duty” and/or provide a substantially instantaneous connection to the service party when the client needs it; (B) reduce, minimize, or remove any need for brick-and-mortar real estate offices and/or “For sale” signs; (C) provide free leads for agents; (D) reduce, minimize, or remove any need for buyer and listing agent advertisements; (E) provides less expensive and more economical referral fees for agents; (F) simply one or more referral processes; (G) provide a large real estate listing site, app, and/or service that is preferably tailored only for local communities; (H) provide a large real estate network without hiring any real estate agent; (I) any agent using the app to become an agent on duty; (J) a service provider and/or administrator of the app to obtain a referral fee each time an on-duty agent completes a real estate transaction; and/or (K) introduce MLS and/or co-broker selling methods to countries beyond the United States and Canada.

According to the invention, the app 100 preferably enables and/or helps: (i) create a large global real estate listing portal; (ii) create a smart multiple listing service and/or multiple agent service portal that can be used worldwide; (iii) provide a client with an instant connection to a nearby on-duty agent, free of charge, with one click; (iv) provide agents with free unlimited local leads; (v) offer agents inexpensive referrals, e.g., at a reduction of perhaps about 70% in comparison to industry standards (e.g., about 6-8% as compared to about 25%); (vi) simplify one or more referral processes between real estate brokerages and/or agents; (vii) provide a business opportunity to tap into real estate transactions globally; and/or (viii) reduces, removes, and/or obviates any need for a real estate agent to list and/or manage any real estate properties of their own, and/or for a brokerage to employ any real estate agents.

The invention is contemplated for use by or in association with an app 100 as described above. The invention, however, is not so limited. Other embodiments, which fall within the scope of the invention, may be provided. For example, other embodiments of the app may be customized for use in other languages 304 (e.g., English, French, Spanish, Italian, Chinese, Portuguese, Romania, Polish, Russian, German, Japanese, Korean). The app 100 may provide potential clients with an option to speak with an agent who can communicate in one or more selected languages.

The app 100 may utilize one or more smart radius algorithms, whereby the app may determine a radius (e.g., about 30 kilometers) for geolocation and connections based on population density, political boundaries, economic data, and/or census data (e.g., population, age). In China, for example, Shanghai may have a population of about 30 million and, as such, the app may use the smart radius algorithms to determine an appropriate connection radius of about 2 kilometers (instead of about 30 kilometers). Whereas, in Canada, the app may use the smart radius algorithms to determine an appropriate connection radius of about 100 kilometers for a rural area in Northern Ontario. The smart radius algorithms of the system may preferably make such determinations with reference to the location and/or density of population.

The service provider and/or administrator of the app may preferably offer one or more premium or other memberships to agents who, e.g., might want to input more than a predetermined number of AOD listings (e.g., three AOD listings).

The app may be adapted for use with other “on duty” service providers and/or service industries, such as, for example, ER service, home renovations, designers, lawyers, doctors, city servants, etc. That is, while the app is preferably particularly adapted for use in a real estate context, it is not so limited. Also or instead, the app may preferably find advantageous utility, with such modifications as appropriate (and obvious, in view of the teachings and disclosures herein, to persons having ordinary skill in the art), in association with plumbers on duty, doctors on duty, lawyers on duty, handymans on duty, etc. and others.

The referral fees charged within the mortgage broker category of the app preferably differ somewhat from those associated with other real estate transactions in the app. For example, the app may charge a referral fee of perhaps about 0.02% of the transaction amount (rather than about 0.2% as may be charged for other real estate sale or lease transactions).

Some embodiments of the app may preferably provide one or more reminders to agents to turn on and/or off duty based on a time zone and/or one or more timers. For example, if the agent has not used the app for some time, the app may preferably generate and/or present a reminder notification on their mobile device, e.g., to remind them to switch “on duty” to serve their own community (or simply “go to work” or the like). In addition or instead, if the app detects that the agent's mobile device has significantly changed locations, the app may preferably generate and/or present a reminder notification on their mobile device, e.g., to suggest that the agent might want to turn off “on duty” to keep from being contacted to show and/or sell properties in unfamiliar areas and/or where they may not be licensed to do so. For example, if an agent from Toronto takes a trip to Cuba for a week's vacation, the app may preferably prompt the agent to turn off “on duty” to avoid receiving calls and/or being asked about Cuba's real estate market nearby to the agent's vacation resort area.

Some embodiments of the app may preferably provide one or more in-app video and/or audio communication features (e.g., in-app video and/or calls).

Some embodiments of the app may preferably restrict and/or lift restrictions on the number of API calls that the app generates to populate MLS listings into the map. For example, the app may restrict the MLS listings to only show a predetermined number of MLS listings (e.g., five MLS listings) to show when a user first opens the app with AOD listings on top. This feature may preferably help to keep costs down, and/or to identify when it may be worthwhile to lift any such restrictions. Some embodiments of the app may allow unlimited API calls for MLS listings—especially, e.g., in high revenue generating areas and/or during high revenue generating times of day.

In other embodiments of the app that fall within the scope of the invention, the app may preferably enable the service provider and/or administrator of the app to selectively display and/or present AOD listings only—i.e., to remove MLS listings and/or to turn off API calls from the app for any MLS listings. Now and in the future, however, the app is preferably adapted to display and/or present all or substantially all listings available on the market to potential buyers, provide agents with increased and/or maximum exposure for their listings, and/or help agents to establish themselves as local experts and/or to obtain valuable leads on potential sales.

Some embodiments of the app may preferably provide a search function for users to filter properties by type, price, features, locations, etc.

Some embodiments of the app may preferably provide, in a property's listing details, a co-broker commission field from a listing agent and/or a FSBO seller to selectively enter a proposed commission amount that is offered for co-broker sales arrangements. The co-broker commission field can preferably only be seen via an agent's account.

The foregoing description has been presented for the purpose of illustration and is not intended to be exhaustive or to limit the invention to the precise form disclosed.

Naturally, in view of the teachings and disclosures herein, persons having ordinary skill in the art may appreciate that alternate designs and/or embodiments of the invention may be possible (e.g., with substitution of one or more components for others, with alternate configurations of components, etc). Although some of the components, relations, configurations and/or steps according to the invention are not specifically referenced in the accompanying drawings or in association with one another, they may be used, and/or adapted for use, in association therewith. For example, features may be depicted or discussed herein in the context of the device, which clearly could be recast as the steps of a method, the inter-workings of a system, and/or recorded on computer readable media. (And, vice-versa.) All of the depicted and aforementioned and various other features, steps, inter-workings, structures, configurations, relationships, utilities, and/or the like (any of which may be depicted and/or based hereon) may be, but are not necessarily, incorporated into and/or achieved by the invention. Any one or more of the depicted and aforementioned features, steps, inter-workings, structures, configurations, relationships, utilities and the like may be implemented in and/or by the invention, on their own, and/or without reference, regard or likewise implementation of any of the other depicted or aforementioned features, steps, inter-workings, structures, configurations, relationships, utilities and the like, in various permutations and combinations, as will be readily apparent to those skilled in the art, without departing from the pith, marrow, and spirit of the disclosed invention.

Other modifications and alterations may be used in the design, manufacture, and/or implementation of other embodiments according to the present invention without departing from the spirit and scope of the invention, which is limited only by the claims of this patent application, and/or of any patent applications claiming priority herefrom.

1. A real estate matching and communication system, for use with at least one real estate property listed as available for a potential transaction by a listing contact, a client's electronic device that is local to a client, and one or more agent electronic devices that are local to agents, including a matching agent's electronic device that is local to a matching agent, wherein the system comprises:
a dedicated application running on the agent electronic devices;
an on-duty button that is presented to the matching agent via the dedicated application and the matching agent's electronic device, and can be selectively engaged by the matching agent to indicate when the matching agent is on-duty;
client listings presented to the client via the client's electronic device that comprise: at least one available real estate listing, corresponding to the real estate property, when the real estate property is physically located within a predetermined property range of the client's electronic device; and an agent-on-duty listing which corresponds to the matching agent when the matching agent is indicated as on-duty and the matching agent's electronic device is physically located within a predetermined agent range of the client's electronic device;
an agent-on-duty communication button, substantially adjacent to the client listings, that is selectively engageable by the client;
an alert notification that is presented to the matching agent, via the dedicated application, after the client has selected the agent-on-duty communication button; whereupon, the client's electronic device and the dedicated application enable live communication, between the client and the matching agent, of inputs received by the client's electronic device and the matching agent's electronic device; wherein the inputs comprise a member selected from the group consisting of text and voice;
an agent listing that presents the available real estate listing to the matching agent via the dedicated application; and
a listing communication button, substantially adjacent to the agent listing, that is selectively engageable by the matching agent to communicate with the listing contact to confirm terms for the potential transaction and arrange for the matching agent to show the real estate property to the client.

2. A system according to claim 1, wherein the available real estate listing comprises a location, one or more photographs, and an asking price associated with the real estate property.

3. A system according to claim 2, wherein the predetermined agent range is automatically predetermined in dependent relation on at least one factor selected from the following: a local population density; a local client density; a local property listing density; and a local agent-on-duty density.

4. A system according to claim 3, further comprising a local map element that presents geographical areas to the client via the client's electronic device; wherein the geographical areas are local to the client's electronic device; wherein the predetermined property range is predetermined in dependent relation on the geographical areas presented via the local map element; and wherein the available real estate listing is presented via the local map element.

5. A system according to claim 4, wherein the local map element can be selectively re-scaled to present the geographical areas at smaller and larger scales and to modify the predetermined property range accordingly.

6. A system according to claim 2, wherein the agent listing also presents the terms for the potential transaction to the matching agent; and wherein the terms comprise a referral fee that the listing contact agrees to pay the matching agent after the potential transaction has successfully closed.

7. A system according to claim 6, further comprising a transaction reporting button that is selectively engageable by the matching agent and the listing contact to report after the potential transaction has successfully closed.

8. A system according to claim 7, further comprising a payment button that is selectively engageable by the listing contact to pay the referral fee to the matching agent, via the dedicated application, after the potential transaction has successfully closed.

9. A system according to claim 8, wherein the system is also for use by an administrator of the dedicated application; wherein the dedicated application pays a portion of the referral fee to the matching agent and a remainder of the referral fee to the administrator, after the listing contact has selected the payment button.

10. A system according to claim 9, further comprising an administrative backend that presents data associated with payment, the terms for the potential transaction, and one or more of the following: the client, the agents, the client listings, communication between the client and the matching agent, and communication between the matching agent and the listing contact.

11. A system according to claim 2, further comprising a posting button that is selectively engageable by the listing contact to post the real estate property before the available real estate listing is presented to the client.

12. A system according to claim 11, wherein the dedicated application presents the posting button to the agents; wherein the posting button is selectively engageable by one of the agents as the listing contact; and wherein the agent-on-duty listing comprises information about the matching agent and any properties directly posted by the matching agent using the posting button.

13. A system according to claim 2, wherein the system is also for use with a Multiple Listing Service database that is remote from the agent electronic devices and the client's electronic device; wherein the client listings further comprise one or more MLS listings reproduced from the Multiple Listing Service database; and wherein the available real estate listing corresponds to one of the MLS listings.

14. A system according to claim 13, wherein the MLS listings are automatically reproduced and downloaded from the Multiple Listing Service database.

15. A method of real estate matching and communication, for use with at least one real estate property listed as available for a potential transaction by a listing contact, a client's electronic device that is local to a client, and one or more agent electronic devices that are local to agents, including a matching agent's electronic device that is local to a matching agent, wherein the method comprises:
a real estate application providing step of providing a dedicated application running on the agent electronic devices;
an on-duty step of providing an on-duty button that is presented to the matching agent via the dedicated application and the matching agent's electronic device, and that enables selective engagement by the matching agent to indicate when the matching agent is on-duty;
a client listing step of presenting client listings to the client via the client's electronic device; wherein the client listings comprise: at least one available real estate listing, corresponding to the real estate property, when the real estate property is physically located within a predetermined property range of the client's electronic device; and an agent-on-duty listing which corresponds to the matching agent when the matching agent is indicated as on-duty and the matching agent's electronic device is physically located within a predetermined agent range of the client's electronic device;
an agent-on-duty communication step of providing: (i) an agent-on-duty communication button, substantially adjacent to the client listings, that is selectively engageable by the client; and (ii) an alert notification that is presented to the matching agent, via the dedicated application, after the client has selected the agent-on-duty communication button; whereupon, the client's electronic device and the dedicated application enable live communication, between the client and the matching agent, of inputs received by the client's electronic device and the matching agent's electronic device; wherein the inputs comprise a member selected from the group consisting of text and voice;
an agent listing step of providing an agent listing that presents the available real estate listing to the matching agent via the dedicated application; and
a listing contact communication step of providing a listing communication button, substantially adjacent to the agent listing, that is selectively engageable by the matching agent to communicate with the listing contact to confirm terms for the potential transaction and arrange for the matching agent to show the real estate property to the client.

16. A method according to claim 15, further comprising an agent range determination step, before the client listing step, wherein the predetermined agent range is automatically predetermined in dependent relation on at least one factor selected from the following: a local population density; a local client density; a local property listing density; and a local agent-on-duty density.

17. A method according to claim 16, wherein in the client listing step, a local map element presents geographical areas to the client via the client's electronic device; wherein the geographical areas are local to the client's electronic device; further comprising a property range determination step, before the client listing step, wherein the predetermined property range is predetermined in dependent relation on the geographical areas presented via the local map element; and wherein, in the client listing step, the available real estate listing is presented via the local map element.

18. A method according to claim 15, wherein in the agent listing step, the agent listing also presents the terms for the potential transaction to the matching agent; wherein the terms comprise a referral fee that the listing contact agrees to pay the matching agent after the potential transaction has successfully closed; and further comprising a transaction reporting step, after the listing contact communication step, of providing a transaction reporting button that is selectively engageable by the matching agent and the listing contact to report after the potential transaction has successfully closed.

19. A method according to claim 18, further comprising a payment step, after the transaction reporting step, of providing a payment button that is selectively engageable by the listing contact to pay the referral fee to the matching agent, via the dedicated application, after the potential transaction has successfully closed.

20. A method according to claim 15, further comprising a posting step, before the client listing step, of providing a posting button that is selectively engageable by the listing contact to post the real estate property before the available real estate listing is presented to the client; wherein the dedicated application presents the posting button to the agents; wherein the posting button is selectively engageable by one of the agents as the listing contact; and wherein the agent-on-duty listing comprises information about the matching agent and any properties directly posted by the matching agent using the posting button.
